(19) United States
(12) Patent Application Publication
(10) Pub. No.: US 2024/0223391 A1
(43) Pub. Date: Jul. 4, 2024

(54) COMMUNICATION METHOD AND RELATED APPARATUS

(71) Applicant: HUAWEI TECHNOLOGIES CO., LTD., Shenzhen (CN)

(72) Inventors: Donghui Wang, Beijing (CN); Fei Liu, Singapore (SG)

(73) Assignee: HUAWEI TECHNOLOGIES CO., LTD., Shenzhen (CN)

(21) Appl. No.: 18/608,829

(22) Filed: Mar. 18, 2024

Related U.S. Application Data
(63) Continuation of application No. PCT/CN2022/114459, filed on Aug. 24, 2022.

(30) Foreign Application Priority Data
Sep. 18, 2021 (CN) 202111112844.1

(51) Int. Cl. H04L 9/00; H04L 9/32

(52) U.S. Cl. CPC H04L 9/50; H04L 9/321

(57) ABSTRACT

According to a communication method, a first communication device obtains a network identifier of a second communication device, generates a query request, sends the query request to a blockchain service device, and receives first blockchain information from the blockchain service device. The query request is used to request the first blockchain information corresponding to the network identifier of the second communication device. The first blockchain information includes a first blockchain identifier, or the first blockchain information includes a first transaction identifier set. The first transaction identifier set includes one or more first transaction identifiers. The first blockchain information is used by the first communication device to query transaction data of the second communication device in a blockchain.

### CROSS-REFERENCE TO RELATED APPLICATIONS

This application is a continuation of International Application No. PCT/CN2022/114459, filed on Aug. 24, 2022, which claims priority to Chinese Patent Application No. 202111112844.1, filed on Sep. 18, 2021. The disclosures of the aforementioned applications are hereby incorporated by reference in their entireties.

### TECHNICAL FIELD

The disclosure relates to the field of blockchain technologies, and in particular, to a communication method and a related apparatus.

### BACKGROUND

A blockchain is a decentralized ledger that cannot be tampered with and that is open and transparent. The blockchain is used to record transaction data in a public or private peer-to-peer network. Data is generated and stored in blocks, and the blocks are connected into a chain data structure in chronological order. The blocks are used to record transaction data, and the blocks are linked according to a hash algorithm, to permanently record historical records of asset transactions between peer nodes in a network.

The blockchain is deployed in the network as a trust anchor or a trust platform. For example, in a decentralized identity (DID) management project and a decentralized public key infrastructure (DPKI) project, a user issues information about a trust credential (for example, an identity certificate and a hash value of the certificate) to a blockchain. Then, the user encapsulates an address (block chain address) of corresponding information in the blockchain into a network protocol-based message and sends the message to a verifier. The verifier searches the blockchain for the information and verifies the trust credential based on the address in the blockchain, to further verify credential information.

It can be learned that the user encapsulates the address of the corresponding information in the blockchain into the network protocol-based message and sends the message to the verifier. Therefore, a related field needs to be added to the network protocol-based message, so that the message carries the address of the corresponding information in the blockchain. Consequently, a network protocol needs to be modified accordingly to support blockchain-based network communication.

### SUMMARY

The disclosure provides a communication method and a related apparatus. The method is used by a first communication device to obtain, from a blockchain device, first blockchain information corresponding to a network identifier of a second communication device. Therefore, the first communication device can query corresponding transaction data in a blockchain based on the first blockchain information. The second communication device does not need to send an address, in a blockchain, of transaction data of the second communication device to the first communication device according to a network protocol. In other words, modification and evolution of the network protocol can be reduced or are not even required, so that a blockchain-based network protocol is compatible with a network protocol of a current communication system.

According to a first aspect, the disclosure provides a communication method, including:

A first communication device obtains a network identifier of a second communication device; generates a query request based on the network identifier of the second communication device; sends the query request to a blockchain service device; and receives first blockchain information from the blockchain service device. The query request is used to request the first blockchain information corresponding to the network identifier of the second communication device; the first blockchain information includes a first blockchain identifier, and the first blockchain identifier is used by the first communication device to query, in a blockchain, first transaction data that is of the second communication device and that is associated with the first blockchain identifier, or the first blockchain information includes a first transaction identifier set, the first transaction identifier set includes one or more first transaction identifiers, and the one or more first transaction identifiers are transaction identifiers, in the blockchain, of one or more pieces of second transaction data of the second communication device; and the first transaction identifier set is used by the first communication device to query the one or more pieces of second transaction data in the blockchain.

It can be learned from the foregoing technical solutions that the first communication device obtains the first blockchain information of the second communication device in the blockchain from the blockchain service device. Therefore, the first communication device can query corresponding transaction data in the blockchain based on the first blockchain information. In other words, a process in which the first communication device obtains, according to a network protocol, the first blockchain information of the second communication device online is converted into bypass querying, to simplify deployment and promotion of blockchain application. Therefore, in the technical solutions of the disclosure, the second communication device does not need to send an address, in the blockchain, of transaction data of the second communication device to the first communication device according to the network protocol. In other words, evolution and upgrade of the network protocol can be reduced or are not even required, and a blockchain service can be directly used. Therefore, a blockchain-based network protocol is compatible with a network protocol of a current communication system. In addition, for a load-sensitive network protocol, blockchain information is separated from the network protocol, to ensure that load of a network protocol-based message does not increase due to introduction of a blockchain technology.

In a possible implementation, the query request includes the network identifier, and the network identifier includes any one of the following: an Internet protocol (IP) address, a media access control (MAC) address, a network layer identifier, a subscription permanent identifier (SUPI), a subscription concealed identifier (SUCI), a globally unique temporary user equipment identifier (GUTI), an international mobile equipment identity (IMEI), a public land mobile network identifier (PLMN_ID), a public key hash value, and domain name information that are of the second communication device.

In this implementation, a plurality of forms of the network identifier are provided. This facilitates implementation of the solutions, so that the solutions can be applied to a plurality of possible network scenarios, for example, an SUPI indicating a subscriber identity module (SIM) card identity, an IMEI indicating a mobile phone identity, a public key hash value indicating a permanent identity in an Internet protocol, an IP address indicating a network address, and a MAC address indicating a device ID or a link-layer address. For example, in an IP routing process, the first communication device may request, from the blockchain service device based on the IP address of the second communication device, first blockchain information corresponding to the IP address. Therefore, the first communication device can query corresponding transaction data in the blockchain based on the first blockchain information. For example, the network identifier may be the IMEI indicating the mobile phone identity. The first communication device requests, from the blockchain service device based on the IMEI, first blockchain information corresponding to the IMEI. Therefore, the first communication device can query corresponding transaction data in the blockchain based on the first blockchain information.

In another possible implementation, the method further includes: The first communication device obtains first authorization information, where the first authorization information is authorization information provided by the second communication device for the query request.

In this implementation, the first communication device may obtain the first authorization information, to determine whether the second communication device allows the first communication device to query the transaction data and some authorization-related information of the second communication device.

In another possible implementation, the query request further includes the first authorization information.

In this implementation, the first communication device may add the first authorization information to the query request, so that the blockchain service device verifies the first authorization information. This improves security of a query service provided by the blockchain service device.

In another possible implementation, the first authorization information includes at least one of the following: the network identifier of the second communication device, a time range within which query is allowed, a network identifier of the first communication device, the first transaction identifier set, and a transaction identifier of the first transaction data.

In this implementation, some content related to the first authorization information is shown. This facilitates implementation of the solutions. For example, the time range within which query is allowed means that the second communication device may limit valid duration of query performed by the first communication device. In addition, some transaction identifiers that the first communication device is allowed to query or transaction identifiers of transaction data associated with blockchain identifiers may further be carried.

In another possible implementation, after the first communication device obtains the network identifier of the second communication device, and before the first communication device sends the query request to the blockchain service device, the method further includes:

The first communication device determines that the first blockchain information corresponding to the network identifier does not exist in the first communication device.

In this implementation, if the first communication device determines that the first blockchain information corresponding to the network identifier does not exist, the first communication device may request the first blockchain information from the blockchain service device. Therefore, the first communication device can query, in the blockchain based on the first blockchain information, transaction data associated with the first blockchain information.

In another possible implementation, the method further includes: The first communication device stores a mapping relationship between the network identifier and the first blockchain information.

In this implementation, the first communication device may store the mapping relationship between the network identifier and the first blockchain information. Therefore, next time the first communication device queries the transaction data associated with the first blockchain information, the first communication device does not need to request the first blockchain information from the blockchain service device.

In another possible implementation, the first blockchain information includes the first blockchain identifier, and the method further includes:

The first communication device queries the first transaction data in the blockchain based on the first blockchain identifier.

In this implementation, after obtaining the first blockchain identifier, the first communication device can query corresponding transaction data in the blockchain, to perform corresponding service determining. In other words, the second communication device does not need to add the first blockchain information to a network transmission procedure or a service procedure between the first communication device and the second communication device. The network protocol does not need to be modified, and the first communication device is supported in querying the first blockchain information corresponding to the network identifier of the second communication device offline.

In another possible implementation, the first blockchain information includes the first transaction identifier set, and the method further includes:

The first communication device queries the one or more pieces of second transaction data in the blockchain based on the first transaction identifier set.

In this implementation, after obtaining the first transaction identifier set, the first communication device can query corresponding transaction data in the blockchain, to perform corresponding service determining. In other words, the second communication device does not need to add the first blockchain information to a network transmission procedure or a service procedure between the first communication device and the second communication device. The network protocol does not need to be modified, and the first communication device is supported in querying the first blockchain information corresponding to the network identifier of the second communication device offline. In addition, in this implementation, the second communication device may disclose specific transaction data in a targeted manner and does not need to provide all transaction data. This improves accuracy of obtaining data by the first communication device.

According to a second aspect, the disclosure provides a communication method, including:

A blockchain service device receives a query request from a first communication device; determines first blockchain information based on the query request; and sends the first blockchain information to the first communication device. The query request is used to request the first blockchain information corresponding to a network identifier of a second communication device; the first blockchain information includes a first blockchain identifier, and the first blockchain identifier is used by the first communication device to query, in a blockchain, first transaction data that is of the second communication device and that is associated with the first blockchain identifier, or the first blockchain information includes a first transaction identifier set, the first transaction identifier set includes one or more first transaction identifiers, and the one or more first transaction identifiers are transaction identifiers, in the blockchain, of one or more pieces of second transaction data of the second communication device; and the first transaction identifier set is used by the first communication device to query the one or more pieces of second transaction data in the blockchain.

In the foregoing technical solutions, the blockchain service device receives the query request from the first communication device and determines the first blockchain information based on the query request. The blockchain service device sends the first blockchain information to the first communication device. Therefore, the first communication device can query corresponding transaction data in the blockchain based on the first blockchain information. In other words, a process in which the first communication device obtains, according to a network protocol, the first blockchain information of the second communication device online is converted into bypass querying, to simplify deployment and promotion of blockchain application. The second communication device does not need to send an address, in the blockchain, of transaction data of the second communication device to the first communication device according to the network protocol. In other words, evolution and upgrade of the network protocol are not required, and a blockchain service can be directly used. Therefore, a blockchain-based network protocol is compatible with a network protocol of a current communication system. In addition, for a load-sensitive network protocol, blockchain information is separated from the network protocol, to ensure that load of a network protocol-based message does not increase due to introduction of a blockchain technology.

In a possible implementation, the query request includes the network identifier, and the network identifier includes any one of the following: an IP address, a MAC address, a network layer identifier, a SUPI, a SUCI, a GUTI, an IMEI, a PLMN_ID, a public key hash value, and domain name information that are of the second communication device.

In this implementation, a plurality of forms of the network identifier are provided. This facilitates implementation of the solutions, so that the solutions can be applied to a plurality of possible network scenarios, for example, an SUPI indicating a SIM card identity, an IMEI indicating a mobile phone identity, a public key hash value indicating a permanent identity in an Internet protocol, an IP address indicating a network address, and a MAC address indicating a device ID or a link-layer address. For example, in an IP routing process, the first communication device may request, from the blockchain service device based on the IP address of the second communication device, first blockchain information corresponding to the IP address. Therefore, the first communication device can query corresponding transaction data in the blockchain based on the first blockchain information. For example, the network identifier may be the IMEI indicating the mobile phone identity. The first communication device requests, from the blockchain service device based on the IMEI, first blockchain information corresponding to the IMEI. Therefore, the first communication device can query corresponding transaction data in the blockchain based on the first blockchain information.

In another possible implementation, the method further includes:

The blockchain service device receives first authorization information from the second communication device, where the first authorization information is authorization information provided by the second communication device for the query request.

In this implementation, the blockchain service device receives the first authorization information from the second communication device, so that the blockchain service device verifies the first authorization information. This improves security of a query service provided by the blockchain service device.

In another possible implementation, the query request further includes the first authorization information, where the first authorization information is authorization information provided by the second communication device for the query request.

In this implementation, another possible implementation in which the blockchain service device obtains the first authorization information, so that the blockchain service device verifies the first authorization information. This improves security of a query service provided by the blockchain service device.

In another possible implementation, the method further includes:

The blockchain service device verifies the first authorization information; and
when verification succeeds, performs the step of sending, by the blockchain service device, the first blockchain information to the first communication device.

In this implementation, the blockchain service device can verify the first authorization information; and when verification succeeds, provide the query service for the first communication device. This improves security of a query service provided by the blockchain service device.

In another possible implementation, the method further includes:

The blockchain service device sends the first authorization information to the first communication device.

In this implementation, the blockchain service device may send the first authorization information to the first communication device, so that the first communication device determines whether the second communication device allows querying, some condition restrictions of allowed querying, and the like.

In another possible implementation, the first authorization information includes at least one of the following: the network identifier of the second communication device, a time range within which query is allowed, a network identifier of the first communication device, the first transaction identifier set, and a transaction identifier of the first transaction data.

In this implementation, some content related to the first authorization information is shown. This facilitates implementation of the solutions. For example, the time range within which query is allowed means that the second communication device may limit valid duration of query performed by the first communication device. In addition, some transaction identifiers that the first communication device is allowed to query or transaction identifiers of transaction data associated with blockchain identifiers may further be carried.

In another possible implementation, the method further includes:

The blockchain service device receives a registration request message from the second communication device, where the registration request message is used to request to establish a mapping relationship between the network identifier and the first blockchain information; verifies the first blockchain information; and when verification of the first blockchain information succeeds, stores the mapping relationship between the network identifier and the first blockchain information.

In this implementation, the second communication device initiates a registration request to the blockchain service device, to request to establish the mapping relationship between the network identifier of the second communication device and the first blockchain information. Therefore, the blockchain service device can establish and store the mapping relationship between the network identifier of the second communication device and the first blockchain information. Therefore, the blockchain service device can provide a service of querying the first blockchain information for the first communication device. The first communication device can query corresponding transaction data in the blockchain based on the first blockchain information, and perform corresponding secure connection and service determining.

In another possible implementation, the method further includes:

The blockchain service device sends a registration response message to the second communication device, where the registration response message indicates that the mapping relationship between the network identifier and the first blockchain information is successfully established.

In this implementation, the blockchain service device may indicate, to the second communication device, that registration succeeds, so that the second communication device can determine that the mapping relationship between the network identifier and the first blockchain information is successfully established. The blockchain service device can provide a service of querying the transaction data associated with the first blockchain information.

In another possible implementation, the method further includes:

The blockchain service device receives a deregistration request message from the second communication device, where the deregistration request message is used to request to delete the mapping relationship between the network identifier and the first blockchain information; and sends a deregistration response message to the second communication device, where the deregistration response message indicates that the blockchain service device deletes the mapping relationship between the network identifier and the first blockchain information.

In this implementation, the second communication device initiates a deregistration request to the blockchain service device, to request to delete the mapping relationship between the network identifier of the second communication device and the first blockchain information. For example, the second communication device does not expect disclosure of the transaction data associated with the first blockchain information. In this case, the second communication device may request to delete the mapping relationship between the network identifier of the second communication device and the first blockchain information. Therefore, the blockchain service device can provide a service of querying the first blockchain information. This can flexibly enable or disable the query service with reference to a requirement of the second communication device.

In another possible implementation, the method further includes:

The blockchain service device receives a modification request message from the second communication device, where the modification request message includes the first blockchain information and second blockchain information; the second blockchain information includes a second blockchain identifier, and the second blockchain identifier is used by the first communication device to query, in the blockchain, third transaction data that is of the second communication device and that is associated with the second blockchain identifier, or the second blockchain information includes a second transaction identifier set, the second transaction identifier set includes one or more second transaction identifiers, the one or more second transaction identifiers are transaction identifiers, in the blockchain, of one or more pieces of fourth transaction data of the second communication device, and the one or more second transaction identifiers are used by the first communication device to query the one or more pieces of fourth transaction data in the blockchain; and the modification request message is used to request to modify the mapping relationship between the network identifier and the first blockchain information to a mapping relationship between the network identifier and the second blockchain information; and sends a modification response message to the second communication device, where the modification response message indicates that the mapping relationship between the network identifier and the first blockchain information is successfully modified.

In this implementation, the second communication device initiates a modification request to the blockchain service device, to request to modify the mapping relationship between the network identifier of the second communication device and the first blockchain information. Therefore, the second communication device can flexibly disclose corresponding transaction data.

According to a third aspect, the disclosure provides a communication method, including:

A second communication device generates a registration request message and sends the registration request message to a blockchain service device. The registration request message is used to request to establish a mapping relationship between a network identifier of the second communication device and first blockchain information of the second communication device, the first blockchain information includes a first blockchain identifier of the second communication device, and the first blockchain identifier is associated with first transaction data of the second communication device, or the first blockchain information includes a first transaction identifier set, the first transaction identifier set includes one or more first transaction identifiers, and the one or more first transaction identifiers are transaction identifiers, in a blockchain, of one or more pieces of second transaction data of the second communication device.

In the foregoing technical solutions, the second communication device initiates a registration request to the blockchain service device, to request to establish the mapping relationship between the network identifier of the second communication device and the first blockchain information. Therefore, the blockchain service device can establish and store the mapping relationship between the network identifier of the second communication device and the first blockchain information. Therefore, the blockchain service device can provide a service of querying the first blockchain information for a first communication device. The first communication device can query corresponding transaction data in the blockchain based on the first blockchain information and perform corresponding secure connection and service determining. The second communication device does not need to send an address of transaction data in the blockchain to the first communication device according to a network protocol. In other words, evolution and upgrade of the network protocol are not required, and a blockchain service can be directly used. Therefore, a blockchain-based network protocol is compatible with a network protocol of a current communication system. In addition, for a load-sensitive network protocol, blockchain information is separated from the network protocol, to ensure that load of a network protocol-based message does not increase due to introduction of a blockchain technology.

In a possible implementation, the registration request message includes the network identifier, and the network identifier includes any one of the following: an IP address, a MAC address, a network layer identifier, a SUPI, a SUCI, a GUTI, an IMEI, a PLMN_ID, a public key hash value, and domain name information that are of the second communication device.

In this implementation, a plurality of forms of the network identifier are provided. This facilitates implementation of the solutions, so that the solutions can be applied to a plurality of possible network scenarios, for example, an SUPI indicating a SIM card identity, an IMEI indicating a mobile phone identity, a public key hash value indicating a permanent identity in an Internet protocol, an IP address indicating a network address, and a MAC address indicating a device ID or a link-layer address. For example, the second communication device may request to establish a mapping relationship between the IP address of the second communication device and the first blockchain information. Therefore, the first communication device can query corresponding transaction data in the blockchain based on the first blockchain information.

In another possible implementation, the method further includes:

The second communication device receives a registration response message from the blockchain service device, where the registration response message indicates that the mapping relationship between the network identifier and the first blockchain information is successfully established.

In this implementation, the blockchain service device may indicate, to the second communication device, that registration succeeds, so that the second communication device can determine that the mapping relationship between the network identifier and the first blockchain information is successfully established. The blockchain service device can provide a service of querying the transaction data associated with the first blockchain information.

In another possible implementation, the method further includes:

The second communication device sends first authorization information, where the first authorization information is authorization information provided by the second communication device for a query request of the first communication device.

In this implementation, the second communication device may send the first authorization information, to notify another communication device whether the first blockchain information of the first communication device is allowed to be queried and some condition restrictions of allowed querying, to improve security and reliability of the query service.

In another possible implementation, the method further includes:

The second communication device sends a deregistration request message to the blockchain service device, where the deregistration request message is used to request to delete the mapping relationship between the network identifier and the first blockchain information; and receives a deregistration response message from the blockchain service device, where the deregistration response message indicates that the blockchain service device deletes the mapping relationship between the network identifier and the first blockchain information.

In this implementation, the second communication device initiates a deregistration request to the blockchain service device, to request to delete the mapping relationship between the network identifier of the second communication device and the first blockchain information. For example, the second communication device does not expect disclosure of the transaction data associated with the first blockchain information. In this case, the second communication device may request to delete the mapping relationship between the network identifier of the second communication device and the first blockchain information. Therefore, the blockchain service device can provide a service of querying the first blockchain information. This can flexibly enable or disable the query service with reference to a requirement of the second communication device.

In another possible implementation, the method further includes:

The second communication device sends a modification request message to the blockchain service device, where the modification request message includes the first blockchain information and second blockchain information; the second blockchain information includes a second blockchain identifier, and the second blockchain identifier is used by the first communication device to query, in the blockchain, third transaction data that is of the second communication device and that is associated with the second blockchain identifier, or the second blockchain information includes a second transaction identifier set, the second transaction identifier set includes one or more second transaction identifiers, the one or more transaction identifiers are transaction identifiers, in the blockchain, of one or more pieces of fourth transaction data of the second communication device, and the one or more second transaction identifiers are used by the first communication device to query the one or more pieces of fourth transaction data in the blockchain; and the modification request message is used to request to modify the mapping relationship between the network identifier and the first blockchain information to a mapping relationship between the network identifier and the second blockchain information; and receives a modification response message from the blockchain service device, where the modification response message indicates that the mapping relationship between the network identifier and the first blockchain information is successfully modified.

In this implementation, the second communication device initiates a modification request to the blockchain service device, to request to modify the mapping relationship between the network identifier of the second communication device and the first blockchain information. Therefore, the second communication device can flexibly disclose corresponding transaction data.

According to a fourth aspect, the disclosure provides a communication apparatus, including:
a transceiver module, configured to obtain a network identifier of a second communication device; and
a processing module, configured to generate a query request based on the network identifier of the second communication device.

The transceiver module is further configured to send the query request to a blockchain service device and receive first blockchain information from the blockchain service device.

The query request is used to request the first blockchain information corresponding to the network identifier of the second communication device; the first blockchain information includes a first blockchain identifier, and the first blockchain identifier is used by the communication apparatus to query, in a blockchain, first transaction data that is of the second communication device and that is associated with the first blockchain identifier, or the first blockchain information includes a first transaction identifier set, the first transaction identifier set includes one or more first transaction identifiers, and the one or more first transaction identifiers are transaction identifiers, in the blockchain, of one or more pieces of second transaction data of the second communication device; and the first transaction identifier set is used by the communication apparatus to query the one or more pieces of second transaction data in the blockchain.

In a possible implementation, the query request includes the network identifier, and the network identifier includes any one of the following: an IP address, a MAC address, a network layer identifier, an SUPI, an SUCI, a GUTI, an IMEI, a PLMN_ID, a public key hash value, and domain name information that are of the second communication device.

In another possible implementation, the transceiver module is further configured to:
obtain first authorization information, where the first authorization information is authorization information provided by the second communication device for the query request.

In another possible implementation, the query request further includes the first authorization information.

In another possible implementation, the first authorization information includes at least one of the following: the network identifier of the second communication device, a time range within which query is allowed, a network identifier of the communication apparatus, the first transaction identifier set, and a transaction identifier of the first transaction data.

In another possible implementation, the processing module is further configured to:
determine that the first blockchain information corresponding to the network identifier does not exist in the communication apparatus.

In another possible implementation, the processing module is further configured to:
store a mapping relationship between the network identifier and the first blockchain information.

In another possible implementation, the first blockchain information includes the first blockchain identifier, and the processing module is further configured to:
query the first transaction data in the blockchain based on the first blockchain identifier.

In another possible implementation, the first blockchain information includes the first transaction identifier set, and the processing module is further configured to:
query the one or more pieces of second transaction data in the blockchain based on the first transaction identifier set.

According to a fifth aspect, the disclosure provides a communication apparatus, including:
a transceiver module, configured to receive a query request from a first communication device; and
a processing module, configured to determine first blockchain information based on the query request.

The transceiver module is further configured to send the first blockchain information to the first communication device.

The query request is used to request the first blockchain information corresponding to the network identifier of the second communication device; the first blockchain information includes a first blockchain identifier, and the first blockchain identifier is used by the first communication device to query, in a blockchain, first transaction data that is of the second communication device and that is associated with the first blockchain identifier, or the first blockchain information includes a first transaction identifier set, the first transaction identifier set includes one or more first transaction identifiers, and the one or more first transaction identifiers are transaction identifiers, in the blockchain, of one or more pieces of second transaction data of the second communication device; and the first transaction identifier set is used by the first communication device to query the one or more pieces of second transaction data in the blockchain.

In a possible implementation, the query request includes the network identifier, and the network identifier includes any one of the following: an IP address, a MAC address, a network layer identifier, a SUPI, a SUCI, a GUTI, an IMEI, a PLMN_ID, a public key hash value, and domain name information that are of the second communication device.

In another possible implementation, the transceiver module is further configured to:
receive first authorization information from the second communication device, where the first authorization information is authorization information provided by the second communication device for the query request.

In another possible implementation, the query request further includes the first authorization information, where the first authorization information is authorization information provided by the second communication device for the query request.

In another possible implementation, the processing module is further configured to:
verify the first authorization information; and when verification succeeds, perform the step of sending the first blockchain information to the first communication device.

In another possible implementation, the transceiver module is further configured to:
send the first authorization information to the first communication device.

In another possible implementation, the first authorization information includes at least one of the following: the network identifier of the second communication device, a time range within which query is allowed, a network identifier of the first communication device, the first transaction identifier set, and a transaction identifier of the first transaction data.

In another possible implementation, the transceiver module is further configured to:
receive a registration request message from the second communication device, where the registration request message is used to request to establish a mapping relationship between the network identifier and the first blockchain information.

The processing module is further configured to:
verify the first blockchain information; and when verification of the first blockchain information succeeds, store the mapping relationship between the network identifier and the first blockchain information.

In another possible implementation, the transceiver module is further configured to:
send a registration response message to the second communication device, where the registration response message indicates that the mapping relationship between the network identifier and the first blockchain information is successfully established.

In another possible implementation, the transceiver module is further configured to:
receive a deregistration request message from the second communication device, where the deregistration request message is used to request to delete the mapping relationship between the network identifier and the first blockchain information; and send a deregistration response message to the second communication device, where the deregistration response message indicates that the communication apparatus deletes the mapping relationship between the network identifier and the first blockchain information.

In another possible implementation, the transceiver module is further configured to:
receive a modification request message from the second communication device, where the modification request message includes the first blockchain information and second blockchain information; the second blockchain information includes a second blockchain identifier, and the second blockchain identifier is used by the first communication device to query, in the blockchain, third transaction data that is of the second communication device and that is associated with the second blockchain identifier, or the second blockchain information includes a second transaction identifier set, the second transaction identifier set includes one or more second transaction identifiers, the one or more second transaction identifiers are transaction identifiers, in the blockchain, of one or more pieces of fourth transaction data of the second communication device, and the one or more second transaction identifiers are used by the first communication device to query the one or more pieces of fourth transaction data in the blockchain; and the modification request message is used to request to modify the mapping relationship between the network identifier and the first blockchain information to a mapping relationship between the network identifier and the second blockchain information; and
send a modification response message to the second communication device, where the modification response message indicates that the mapping relationship between the network identifier and the first blockchain information is successfully modified.

According to a sixth aspect, the disclosure provides a communication apparatus, including:
a processing module, configured to generate a registration request message; and
a transceiver module, configured to send the registration request message to a blockchain service device.

The registration request message is used to request to establish a mapping relationship between a network identifier of the communication apparatus and first blockchain information of the communication apparatus, the first blockchain information includes a first blockchain identifier of the communication apparatus, and the first blockchain identifier is associated with first transaction data of the communication apparatus, or the first blockchain information includes a first transaction identifier set, the first transaction identifier set includes one or more first transaction identifiers, and the one or more first transaction identifiers are transaction identifiers, in a blockchain, of one or more pieces of second transaction data of the communication apparatus.

In a possible implementation, the registration request message includes the network identifier, and the network identifier includes any one of the following: an IP address, a MAC address, a network layer identifier, a SUPI, a SUCI, a GUTI, an IMEI, a PLMN_ID, a public key hash value, and domain name information that are of the communication apparatus.

In another possible implementation, the transceiver module is further configured to:
receive a registration response message from the blockchain service device, where the registration response message indicates that the mapping relationship between the network identifier and the first blockchain information is successfully established.

In another possible implementation, the transceiver module is further configured to:
send first authorization information, where the first authorization information is authorization information provided by the communication apparatus for a query request of the first communication device.

In another possible implementation, the transceiver module is further configured to:
send a deregistration request message to the blockchain service device, where the deregistration request message is used to request to delete the mapping relationship between the network identifier and the first blockchain information; and
receive a deregistration response message from the blockchain service device, where the deregistration response message indicates that the blockchain service device deletes the mapping relationship between the network identifier and the first blockchain information.

In another possible implementation, the transceiver module is further configured to:
send a modification request message to the blockchain service device, where the modification request message includes the first blockchain information and second blockchain information; the second blockchain information includes a second blockchain identifier, and the second blockchain identifier is used by the first communication device to query, in the blockchain, third transaction data that is of the communication apparatus and that is associated with the second blockchain identifier, or the second blockchain information includes a second transaction identifier set, the second transaction identifier set includes one or more second transaction identifiers, the one or more transaction identifiers are transaction identifiers, in the blockchain, of one or more pieces of fourth transaction data of the communication apparatus, and the one or more second transaction identifiers are used by the first communication device to query the one or more pieces of fourth transaction data in the blockchain; and the modification request message is used to request to modify the mapping relationship between the network identifier and the first blockchain information to a mapping relationship between the network identifier and the second blockchain information; and
receive a modification response message from the blockchain service device, where the modification response message indicates that the mapping relationship between the network identifier and the first blockchain information is successfully modified.

According to a seventh aspect, the disclosure provides a communication apparatus. The communication apparatus includes an input/output interface and a logic circuit.

The input/output interface is configured to obtain a network identifier of a second communication device.

The logic circuit is configured to generate a query request based on the network identifier of the second communication device.

The input/output interface is further configured to send the query request to a blockchain service device and receive first blockchain information from the blockchain service device.

The query request is used to request the first blockchain information corresponding to the network identifier of the second communication device; the first blockchain information includes a first blockchain identifier, and the first blockchain identifier is used by the communication apparatus to query, in a blockchain, first transaction data that is of the second communication device and that is associated with the first blockchain identifier, or the first blockchain information includes a first transaction identifier set, the first transaction identifier set includes one or more first transaction identifiers, and the one or more first transaction identifiers are transaction identifiers, in the blockchain, of one or more pieces of second transaction data of the second communication device; and the first transaction identifier set is used by the communication apparatus to query the one or more pieces of second transaction data in the blockchain.

In a possible implementation, the query request includes the network identifier, and the network identifier includes any one of the following: an IP address, a MAC address, a network layer identifier, an SUPI, an SUCI, a GUTI, an IMEI, a PLMN_ID, a public key hash value, and domain name information that are of the second communication device.

In another possible implementation, the input/output interface is further configured to:

Obtain first authorization information, where the first authorization information is authorization information provided by the second communication device for the query request.

In another possible implementation, the query request further includes the first authorization information.

In another possible implementation, the first authorization information includes at least one of the following: the network identifier of the second communication device, a time range within which query is allowed, a network identifier of the communication apparatus, the first transaction identifier set, and a transaction identifier of the first transaction data.

In another possible implementation, the logic circuit is further configured to:
determine that the first blockchain information corresponding to the network identifier does not exist in the communication apparatus.

In another possible implementation, the logic circuit is further configured to:
store a mapping relationship between the network identifier and the first blockchain information.

In another possible implementation, the first blockchain information includes the first blockchain identifier, and the logic circuit is further configured to:
query the first transaction data in the blockchain based on the first blockchain identifier.

In another possible implementation, the first blockchain information includes the first transaction identifier set, and the logic circuit is further configured to:
query the one or more pieces of second transaction data in the blockchain based on the first transaction identifier set.

According to an eighth aspect, the disclosure provides a communication apparatus. The communication apparatus includes an input/output interface and a logic circuit.

The input/output interface is configured to receive a query request from a first communication device.

The logic circuit is configured to determine first blockchain information based on the query request.

The input/output interface is further configured to send the first blockchain information to the first communication device.

The query request is used to request the first blockchain information corresponding to a network identifier of a second communication device; the first blockchain information includes a first blockchain identifier, and the first blockchain identifier is used by the first communication device to query, in a blockchain, first transaction data that is of the second communication device and that is associated with the first blockchain identifier, or the first blockchain information includes a first transaction identifier set, the first transaction identifier set includes one or more first transaction identifiers, and the one or more first transaction identifiers are transaction identifiers, in the blockchain, of one or more pieces of second transaction data of the second communication device; and the first transaction identifier set is used by the first communication device to query the one or more pieces of second transaction data in the blockchain.

In a possible implementation, the query request includes the network identifier, and the network identifier includes any one of the following: an IP address, a MAC address, a network layer identifier, an SUPI, an SUCI, a GUTI, an IMEI, a PLMN_ID, a public key hash value, and domain name information that are of the second communication device.

In another possible implementation, the logic circuit is further configured to:
receive first authorization information from the second communication device, where the first authorization information is authorization information provided by the second communication device for the query request.

In another possible implementation, the query request further includes the first authorization information, where the first authorization information is authorization information provided by the second communication device for the query request.

In another possible implementation, the logic circuit is further configured to:
verify the first authorization information; and when verification succeeds, perform the step of sending the first blockchain information to the first communication device.

In another possible implementation, the input/output interface is further configured to:
send the first authorization information to the first communication device.

In another possible implementation, the first authorization information includes at least one of the following: the network identifier of the second communication device, a time range within which query is allowed, a network identifier of the first communication device, the first transaction identifier set, and a transaction identifier of the first transaction data.

In another possible implementation, the input/output interface is further configured to:
receive a registration request message from the second communication device, where the registration request message is used to request to establish a mapping relationship between the network identifier and the first blockchain information.

The logic circuit is further configured to:
verify the first blockchain information; and when verification of the first blockchain information succeeds, store the mapping relationship between the network identifier and the first blockchain information.

In another possible implementation, the input/output interface is further configured to:
send a registration response message to the second communication device, where the registration response message indicates that the mapping relationship between the network identifier and the first blockchain information is successfully established.

In another possible implementation, the input/output interface is further configured to:
receive a deregistration request message from the second communication device, where the deregistration request message is used to request to delete the mapping relationship between the network identifier and the first blockchain information; and send a deregistration response message to the second communication device, where the deregistration response message indicates that the communication apparatus deletes the mapping relationship between the network identifier and the first blockchain information.

In another possible implementation, the input/output interface is further configured to:
receive a modification request message from the second communication device, where the modification request message includes the first blockchain information and second blockchain information; the second blockchain information includes a second blockchain identifier, and the second blockchain identifier is used by the first communication device to query, in the blockchain, third transaction data that is of the second communication device and that is associated with the second blockchain identifier, or the second blockchain information includes a second transaction identifier set, the second transaction identifier set includes one or more second transaction identifiers, the one or more second transaction identifiers are transaction identifiers, in the blockchain, of one or more pieces of fourth transaction data of the second communication device, and the one or more second transaction identifiers are used by the first communication device to query the one or more pieces of fourth transaction data in the blockchain; and the modification request message is used to request to modify the mapping relationship between the network identifier and the first blockchain information to a mapping relationship between the network identifier and the second blockchain information; and
send a modification response message to the second communication device, where the modification response message indicates that the mapping relationship between the network identifier and the first blockchain information is successfully modified.

According to a ninth aspect, the disclosure provides a communication apparatus. The communication apparatus includes an input/output interface and a logic circuit.

The logic circuit is configured to generate a registration request message.

The input/output interface is configured to send the registration request message to a blockchain service device.

The registration request message is used to request to establish a mapping relationship between a network identifier of the communication apparatus and first blockchain information of the communication apparatus, the first blockchain information includes a first blockchain identifier of the communication apparatus, and the first blockchain identifier is associated with first transaction data of the communication apparatus, or the first blockchain information includes a first transaction identifier set, the first transaction identifier set includes one or more first transaction identifiers, and the one or more first transaction identifiers are transaction identifiers, in a blockchain, of one or more pieces of second transaction data of the communication apparatus.

In a possible implementation, the registration request message includes the network identifier, and the network identifier includes any one of the following: an IP address, a MAC address, a network layer identifier, an SUPI, an SUCI, a GUTI, an IMEI, a PLMN_ID, a public key hash value, and domain name information that are of the communication apparatus.

In another possible implementation, the input/output interface is further configured to:
receive a registration response message from the blockchain service device, where the registration response message indicates that the mapping relationship between the network identifier and the first blockchain information is successfully established.

In another possible implementation, the input/output interface is further configured to:
send first authorization information, where the first authorization information is authorization information provided by the communication apparatus for a query request of the first communication device.

In another possible implementation, the input/output interface is further configured to:
send a deregistration request message to the blockchain service device, where the deregistration request message is used to request to delete the mapping relationship between the network identifier and the first blockchain information; and
receive a deregistration response message from the blockchain service device, where the deregistration response message indicates that the blockchain service device deletes the mapping relationship between the network identifier and the first blockchain information.

In another possible implementation, the input/output interface is further configured to:
send a modification request message to the blockchain service device, where the modification request message includes the first blockchain information and second blockchain information; the second blockchain information includes a second blockchain identifier, and the second blockchain identifier is used by the first communication device to query, in the blockchain, third transaction data that is of the communication apparatus and that is associated with the second blockchain identifier, or the second blockchain information includes a second transaction identifier set, the second transaction identifier set includes one or more second transaction identifiers, the one or more transaction identifiers are transaction identifiers, in the blockchain, of one or more pieces of fourth transaction data of the communication apparatus, and the one or more second transaction identifiers are used by the first communication device to query the one or more pieces of fourth transaction data in the blockchain; and the modification request message is used to request to modify the mapping relationship between the network identifier and the first blockchain information to a mapping relationship between the network identifier and the second blockchain information; and
receive a modification response message from the blockchain service device, where the modification response message indicates that the mapping relationship between the network identifier and the first blockchain information is successfully modified.

According to a tenth aspect, the disclosure provides a communication apparatus. The communication apparatus includes a processor. The processor is configured to invoke a computer program or computer instructions in a memory, to enable the processor to implement any implementation in any one of the first aspect to the third aspect.

Optionally, the communication apparatus further includes the memory.

Optionally, the memory and the processor are integrated together.

Optionally, the communication apparatus further includes a transceiver, and the processor is configured to control the transceiver to receive and send signals.

According to an eleventh aspect, the disclosure provides a computer program product including instructions. When the computer program product runs on a computer, the computer is enabled to perform any implementation in any one of the first aspect to the third aspect.

According to a twelfth aspect, the disclosure provides a computer-readable storage medium, including computer instructions. When the instructions are run on a computer, the computer is enabled to perform any implementation in any one of the first aspect to the third aspect.

According to a thirteenth aspect, the disclosure provides a chip apparatus, including a processor, configured to invoke a computer program or computer instructions in a memory, to enable the processor to perform any implementation in any one of the first aspect to the third aspect.

Optionally, the processor is coupled to the memory through an interface.

According to a fourteenth aspect, the disclosure provides a communication system. The communication system includes the first communication device in the first aspect, the blockchain service device in the second aspect, and the second communication device in the third aspect.

According to the foregoing technical solutions, it can be learned that embodiments of the disclosure have the following advantages:

It can be learned from the foregoing technical solutions that the first communication device may request the first blockchain information corresponding to the network identifier of the second communication device from the blockchain service device, to obtain the first blockchain information of the second communication device in the blockchain. Therefore, the first communication device can query corresponding transaction data in the blockchain based on the first blockchain information. In other words, the process in which the first communication device obtains, according to the network protocol, the first blockchain information of the second communication device online is converted into the bypass querying, to simplify deployment and promotion of blockchain application. The second communication device does not need to send the address of the transaction data in the blockchain to the first communication device according to the network protocol. In other words, according to the technical solutions of the disclosure, evolution and upgrade of the network protocol can be reduced or are not even required, and a blockchain service can be directly used. Therefore, a blockchain-based network protocol is compatible with a network protocol of a current communication system. In addition, for a load-sensitive network protocol, blockchain information is separated from the network protocol, to ensure that load of a network protocol-based message does not increase due to introduction of a blockchain technology.

### BRIEF DESCRIPTION OF DRAWINGS

FIG. 1 is a schematic diagram of a communication system according to an embodiment of the disclosure.

FIG. 2 is a schematic diagram of an embodiment of a communication method according to an embodiment of the disclosure.

FIG. 3 is a schematic diagram of mapping between a network identifier and a first blockchain identifier according to an embodiment of the disclosure.

FIG. 4 is a schematic diagram of mapping between a network identifier and a first transaction identifier set according to an embodiment of the disclosure.

FIG. 5 is a schematic diagram of another embodiment of a communication method according to an embodiment of the disclosure.

FIG. 6 is a schematic diagram of another embodiment of a communication method according to an embodiment of the disclosure.

FIG. 7 is a schematic diagram of another embodiment of a communication method according to an embodiment of the disclosure.

FIG. 8 is a schematic diagram of a structure of a communication apparatus according to an embodiment of the disclosure.

FIG. 9 is a schematic diagram of another structure of a communication apparatus according to an embodiment of the disclosure.

FIG. 10 is a schematic diagram of another structure of a communication apparatus according to an embodiment of the disclosure.

FIG. 11 is a schematic diagram of another structure of a communication apparatus according to an embodiment of the disclosure.

FIG. 12 is a schematic diagram of another structure of a communication apparatus according to an embodiment of the disclosure.

FIG. 13 is a schematic diagram of another structure of a communication apparatus according to an embodiment of the disclosure.

FIG. 14 is a schematic diagram of another structure of a communication apparatus according to an embodiment of the disclosure.

### DESCRIPTION OF EMBODIMENTS

Embodiments of the disclosure provide a communication method and a related apparatus. The method is used by a first communication device to obtain, from a blockchain device, first blockchain information corresponding to a network identifier of a second communication device. Therefore, the first communication device can query corresponding transaction data in a blockchain based on the first blockchain information. The second communication device does not need to send an address, in the blockchain, of transaction data of the second communication device to the first communication device according to a network protocol. Therefore, evolution and upgrade of the network protocol can be reduced or are not even required, so that a blockchain-based network protocol is compatible with a network protocol of a current communication system.

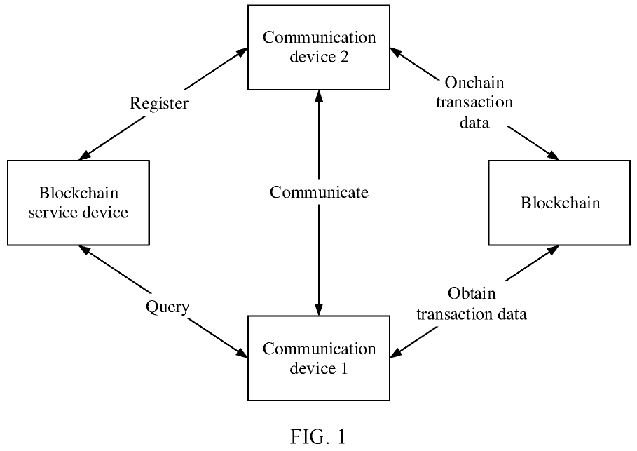

FIG. 1 is a schematic diagram of a communication system according to an embodiment of the disclosure. Refer to FIG. 1. The communication system includes a blockchain service device, a first communication device (e.g., communication device 1), a second communication device (e.g. communication device 2), and a blockchain.

The blockchain service device has a blockchain address service (BCAS) function and is configured to provide a mapping service between a network identifier of a communication device and blockchain information of the communication device in a blockchain. The network identifier of the communication device may be an IP address, a MAC address, or the like of the communication device. The blockchain information of the communication device includes a blockchain identifier of the communication device in the blockchain, or a transaction identifier of transaction data of the communication device in the blockchain.

The BCAS may be understood as an independent network service, and may be deployed in a network server, a computer device, a computer, a terminal device, user equipment, a cloud device, or the like. In other words, in the technical solutions of the disclosure, the blockchain service device includes a network server, a computer device, a computer, a terminal device, user equipment, a cloud device, or the like.

The communication device 2 may register with the blockchain service device, to establish a mapping relationship between a network identifier of the communication device 2 and blockchain information of the communication device 2. The communication device 1 obtains the network identifier of the communication device 2 when the communication device 1 communicates with the communication device 2, and queries, from the blockchain service device based on the network identifier, blockchain information corresponding to the network identifier. After obtaining the blockchain information, the communication device 1 can query, in the blockchain based on the blockchain information, transaction data corresponding to the communication device 2.

In the disclosure, the communication device may be a router, a switch, a server, a gateway device, a network device, a client device, a terminal device, user equipment, or the like. The terminal device may be a mobile phone, a notebook computer, a tablet computer, a wireless terminal in industrial control, a wireless terminal in the Internet of vehicles, an uncrewed aerial vehicle, a wireless terminal in self-driving, a wireless terminal in a smart grid, a wireless terminal in transportation safety, or the like. For example, the wireless terminal in the Internet of vehicles may be a vehicle-mounted device, an entire vehicle device, a vehicle-mounted module, a vehicle, or the like. The wireless terminal in industrial control may be a camera, a robot, or the like.

The technical solutions of the disclosure are described below with reference to specific embodiments.

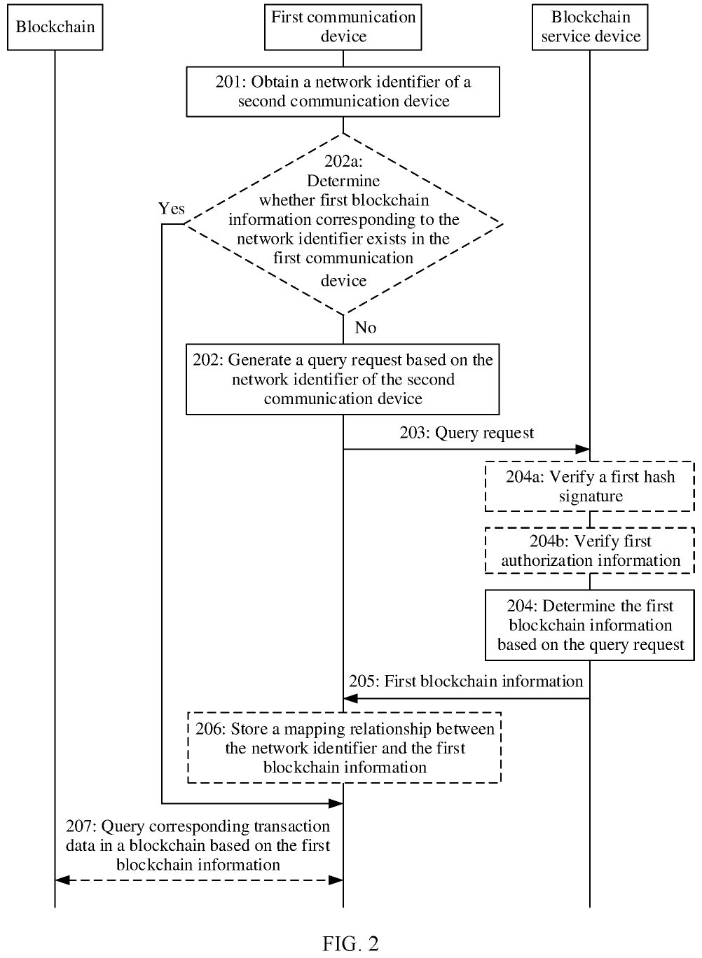

FIG. 2 is a schematic diagram of an embodiment of a communication method according to an embodiment of the disclosure. Refer to FIG. 2. The method includes the following blocks.

201: A first communication device obtains a network identifier of a second communication device.

The network identifier of the second communication device is information that can uniquely identify an identity of the second communication device in a network.

Optionally, the network identifier includes any one of the following: an IP address, a MAC address, a network layer identifier (namely, content of an extension header of an IP packet), an SUPI, an SUCI, a GUTI, an IMEI, a PLMN_ID, a public key hash value, and domain name information that are of the second communication device. For example, the domain name information of the second communication device includes a uniform resource locator (URL) of the second communication device. Another network identifier of the second communication device is still applicable to the disclosure. This is not specifically limited in the disclosure. The foregoing example does not constitute a limitation on the disclosure.

In some implementations, block 201 specifically includes: The first communication device receives a network connection request or a service request from the second communication device. The network connection request or the service request includes the network identifier of the second communication device.

For example, the network connection request includes a secure connection request or a handshake message according to the transport layer security (TLS) protocol. The secure connection request may be a request according to the internet protocol security (IPsec), the domain name system (DNS) protocol, or the border gateway protocol (BGP).

202: The first communication device generates a query request based on the network identifier of the second communication device.

The query request is used to request first blockchain information corresponding to the network identifier of the second communication device. Optionally, the query request includes the network identifier of the second communication device.

The following describes two possible implementations of the first blockchain information.

1. The first blockchain information includes a first blockchain identifier (BC_ID), and the first blockchain identifier is used by the first communication device to query, in a blockchain, first transaction data that is of the second communication device and that is associated with the first blockchain identifier.

The first blockchain identifier is a first identifier of the second communication device in the blockchain. For example, the second communication device establishes a plurality of blockchain accounts in the blockchain, and the first blockchain identifier is an identifier, in the blockchain, of one of the blockchain accounts of the second communication device. The first blockchain identifier may be understood as an address, in the blockchain, of transaction data of the blockchain account of the second communication device.

2. The first blockchain information includes a first transaction identifier set, and the first transaction identifier set includes one or more first transaction identifiers. The one or more first transaction identifiers are transaction identifiers, in the blockchain, of one or more pieces of second transaction data of the second communication device. The first transaction identifier set is used by the first communication device to query the one or more pieces of second transaction data in the blockchain.

For example, the first transaction identifier set includes the plurality of first transaction identifiers, and the plurality of first transaction identifiers may be identified in a form of a transaction list. For example, a first transaction identifier list is {BC_TX1, BC_TX2, . . . }.

It should be noted that the one or more pieces of second transaction data may include the first transaction data, or may be a portion of the first transaction data. For example, the first transaction data is transaction data associated with a first blockchain account of the second communication device. The one or more pieces of second transaction data may be a portion of the transaction data associated with the first blockchain account. Alternatively, the second communication device registers a plurality of blockchain accounts with the blockchain, and the first transaction data is transaction data associated with one of the blockchain accounts. The one or more pieces of second transaction data are a portion or all of transaction data associated with the plurality of blockchain accounts.

Optionally, the query request further includes a first hash signature. The first communication device performs a hash operation on a network identifier of the first communication device, and then performs digital signing, to obtain the first hash signature.

In some implementations, the first communication device obtains first authorization information, where the first authorization information is authorization information provided by the second communication device for the query request.

Optionally, the first authorization information includes at least one of the following: the network identifier of the second communication device, a time range within which query is allowed, the network identifier of the first communication device, the first transaction identifier set, a transaction identifier of the first transaction data, and a second hash signature. The second communication device performs hash signing on the network identifier of the second communication device, the time range within which query is allowed, the network identifier of the first communication device, the first transaction identifier set, the transaction identifier of the first transaction data, and then performs digital signing, to obtain the second hash signature.

For example, the time range within which query is allowed may be duration that starts from sending time at which the second communication device sends the first authorization information and in which the first communication device is allowed to query corresponding transaction data of the second communication device in the blockchain.

The following describes some possible implementations in which the first communication device obtains the first authorization information.

Implementation 1: The first communication device receives the first authorization information from the second communication device.

Specifically, the second communication device may send the first authorization information to the first communication device based on a service request. The first communication device obtains the first authorization information based on the service request.

In the implementation 1, optionally, the query request in block 202 further includes the first authorization information.

Implementation 2: The first communication device receives the first authorization information from a blockchain service device.

Specifically, the first communication device may determine, with reference to the first authorization information, whether the transaction data of the second communication device is allowed to be queried, the time range within which query is allowed, and the like.

Optionally, the embodiment shown in FIG. 2 further includes block 202a. Block 202a may be performed before block 202.

202a: The first communication device determines whether the first blockchain information corresponding to the network identifier of the second communication device exists in the first communication device; and if the first blockchain information corresponding to the network identifier of the second communication device exists in the first communication device, performs block 207; or if the first blockchain information corresponding to the network identifier of the second communication device does not exist in the first communication device, performs block 202.

Before performing querying, the first communication device may determine whether the first blockchain information corresponding to the network identifier of the second communication device exists in the first communication device. If the first blockchain information corresponding to the network identifier of the second communication device does not exist in the first communication device, the first communication device may generate the query request based on the network identifier of the second communication device and send the query request to the blockchain service device. If the first blockchain information corresponding to the network identifier of the second communication device exists in the first communication device, the first communication device does not need to perform querying. For example, the first communication device may perform block 207 in the following.

203: The first communication device sends the query request to the blockchain service device.

204: The blockchain service device determines the first blockchain information based on the query request.

Specifically, the query request includes the network identifier of the second communication device. The blockchain service device stores the first blockchain information and the mapping relationship between the network identifier of the second communication device and the first blockchain information. The blockchain service device may determine the first blockchain information corresponding to the network identifier of the second communication device based on the mapping relationship.

Optionally, the query request further includes the first hash signature. In this implementation, optionally, the embodiment shown in FIG. 2 further includes block 204a. Block 204a may be performed before block 204.

204a: The blockchain service device verifies the first hash signature.

Specifically, the query request includes the first hash signature. The first communication device performs a hash operation on the network identifier of the first communication device, and then performs digital signing, to obtain the first hash signature. The blockchain service device verifies the first hash signature; and when verification succeeds, performs block 204.

It should be noted that when verification fails, the blockchain service device may send a query failure to the first communication device, to indicate that the blockchain service device refuses to provide the first blockchain information for the first communication device.

Optionally, the blockchain service device obtains the first authorization information, where the first authorization information is authorization information of the second communication device for the query request. For details about the first authorization information, refer to the foregoing related descriptions.

The following describes two possible implementations in which the blockchain service device obtains the first authorization information.

Implementation 1: The blockchain service device receives the first authorization information from the second communication device.

In the implementation 1, optionally, the blockchain service device sends the first authorization information to the first communication device.

Implementation 2: The blockchain service device receives the first authorization information from the first communication device.

In the implementation 2, optionally, the query request includes the first authorization information. The blockchain service device obtains the first authorization information based on the query request.

Optionally, the embodiment shown in FIG. 2 further includes block 204b. Block 204b may be performed after or before block 204a.

204b: The blockchain service device verifies the first authorization information.

For example, the blockchain service device performs block 204a. When verification of the first hash signature succeeds, the blockchain service device may verify the first authorization information. When verification of the first authorization information succeeds, the blockchain service device performs block 204.

For example, the block service device may verify the first authorization information. When verification of the first authorization information succeeds, the blockchain service device performs block 204b. When verification of the first hash signature succeeds, the blockchain service device performs block 204.

The following describes a specific process in which the blockchain service device verifies the first authorization information.

The blockchain service device may verify the second hash signature of the first authorization information. If verification of the second hash signature succeeds, the blockchain service device may verify authorization content included in the first authorization information. For example, the blockchain service device verifies whether the authorization content is authorized to the first communication device (specifically verifies whether the authorization content includes the network identifier of the first communication device) and whether query can be performed currently (which may specifically be determined based on the time range within which query is allowed).

It should be noted that when verification of the first authorization information fails, the blockchain service device may send a query failure message to the first communication device, to indicate that the blockchain service device refuses to provide the first blockchain information for the first communication device.

It can be learned that there is no fixed sequence between block 204a and block 204b. Block 204a may be performed before block 204b, block 204b may be performed before block 204a, or block 204a and block 204b are performed at the same time based on a situation.

205: The blockchain service device sends the first blockchain information to the first communication device.

After determining the first blockchain information based on the query request, the blockchain service device may send the first blockchain information corresponding to the network identifier to the first communication device.

Optionally, the embodiment shown in FIG. 2 further includes block 206 and block 207. Block 206 and block 207 may be performed after block 205.

206: The first communication device stores the mapping relationship between the network identifier and the first blockchain information.

Specifically, the first communication device may store the mapping relationship between the network identifier and the first blockchain information. Therefore, next time the first communication device queries the transaction data associated with the first blockchain information, the first communication device does not need to request the first blockchain information from the blockchain service device.

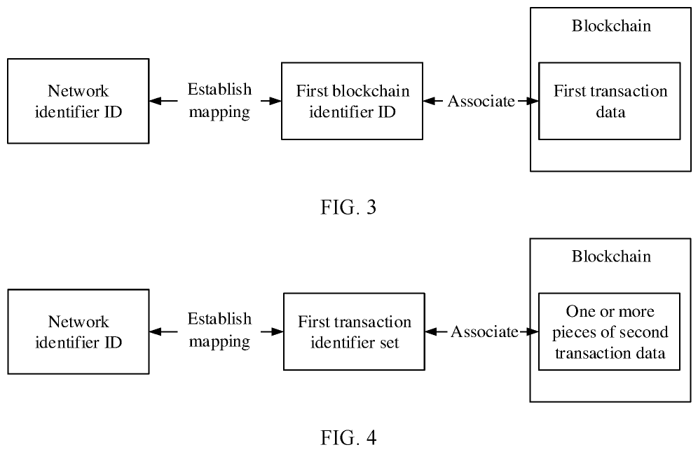

For example, as shown in FIG. 3, the first blockchain information includes the first blockchain identifier, and the first blockchain identifier is associated with the first transaction data of the second communication device in the blockchain. The first communication device stores a mapping relationship between the network identifier and the first blockchain identifier.

For example, as shown in FIG. 4, the first blockchain information includes the first transaction identifier set. The first transaction identifier set includes the transaction identifiers, in the blockchain, of the one or more pieces of second transaction data of the second communication device. The first communication device stores a mapping relationship between the network identifier and the first transaction identifier set.

207: The first communication device can query corresponding transaction data in the blockchain based on the first blockchain information.

In a possible implementation, as shown in FIG. 3, the first communication device may obtain the first transaction data through querying in the blockchain based on the first blockchain identifier.

In another possible implementation, as shown in FIG. 4, the first communication device may obtain the one or more pieces of second transaction data through querying in the blockchain based on the first transaction identifier set.

For example, the first communication device is a router 1, and the second communication device is a router 2. The router 1 and the router 2 establish a routing connection according to the BGP. The router 1 needs to verify a blockchain certificate of the router 2. In this case, the router 1 may obtain the blockchain certificate of the router 2 from the blockchain based on the blockchain information corresponding to the network identifier of the router 2, and verify the blockchain certificate.

For another example, the first communication device and the second communication device are two network communication nodes. The blockchain service device establishes a mapping relationship between a network layer identifier of the second communication device and the first blockchain information. The second communication device may request the first blockchain information from the blockchain service device, and query a historical behavior (for example, an access record of the second communication device) of the second communication device in the blockchain based on the first blockchain information, to determine reliability of the second communication device.

It can be seen that there is a mapping relationship between the network identifier of the second communication device and the first blockchain information. The blockchain service device can provide an enabled service of querying the mapping relationship. The first communication device may request the first blockchain information corresponding to the network identifier of the second communication device from the blockchain service device, to obtain the first blockchain information of the second communication device in the blockchain. Therefore, the first communication device can query corresponding transaction data in the blockchain based on the first blockchain information and perform corresponding secure connection and service determining. In other words, the second communication device does not need to add the first blockchain information to a network transmission procedure or a service procedure between the first communication device and the second communication device. The network protocol does not need to be modified, and the first communication device is supported in querying the first blockchain information corresponding to the network identifier of the second communication device offline. In addition, a communication message between the first communication device and the second communication device does not need to carry the blockchain information. This can avoid heavy load caused by carrying much information in the message. For example, in an internet of things (IOT) network, energy carried by a data frame is weak. For example, in the 802.15.4 protocol, a maximum length of a data frame is 127 bytes, and a length of one byte is 256 bits. If a plurality of pieces of transaction information need to be carried, a huge challenge is imposed on load of the data frame. According to the technical solutions of the disclosure, the blockchain information does not need to be carried in the data frame.

For example, the blockchain certificate is encapsulated in a message of the IPsec-based internet key exchange (IKE) protocol, that is, a corresponding field needs to be added to the message to carry the blockchain certificate. In this case, the IPsec protocol needs to be modified. Consequently, a blockchain-based IPsec protocol cannot adapt to the IPsec protocol in the current communication system. For example, the blockchain certificate is encapsulated in the handshake message according to the TLS protocol. In other words, a corresponding field needs to be added to the message to carry the blockchain certificate. In this case, the TLS protocol needs to be modified. Consequently, a blockchain-based TLS protocol cannot adapt to the TLS protocol in the current communication system. For example, the blockchain certificate is encapsulated in the handshake message according to the DNS protocol or the BGP. In other words, a corresponding field needs to be added to the message to carry the blockchain certificate. In this case, the DNS protocol or the BGP needs to be modified. Consequently, a blockchain-based DNS protocol or BGP cannot adapt to the DNS protocol or the BGP in the current communication system. According to the technical solutions in the embodiment shown in FIG. 2, the first communication device may request the first blockchain information corresponding to the network identifier of the second communication device from the blockchain service device. Then, the first communication device can query corresponding transaction data (including the blockchain certificate and the like) in the blockchain based on the first blockchain information. The network protocol does not need to be modified, so that a blockchain-based network protocol can adapt to the network protocol in the current communication system. Therefore, a blockchain-based communication system is compatible with the network protocol of the current communication system.

In embodiments of the disclosure, the first communication device obtains the network identifier of the second communication device. The first communication device generates the query request based on the network identifier of the second communication device. Then, the first communication device sends the query request to the blockchain service device. The first communication device receives the first blockchain information from the blockchain service device. The query request is used to request the first blockchain information corresponding to the network identifier of the second communication device; the first blockchain information includes the first blockchain identifier, and the first blockchain identifier is used by the first communication device to query, in the blockchain, the first transaction data that is of the second communication device and that is associated with the first blockchain identifier, or the first blockchain information includes the first transaction identifier set, the first transaction identifier set includes the one or more first transaction identifiers, and the one or more first transaction identifiers are the transaction identifiers, in the blockchain, of the one or more pieces of second transaction data of the second communication device; and the first transaction identifier set is used by the first communication device to query the one or more pieces of second transaction data in the blockchain. It can be learned that, in the technical solutions of the disclosure, the first communication device may request the first blockchain information corresponding to the network identifier of the second communication device from the blockchain service device, to obtain the first blockchain information of the second communication device in the blockchain. Therefore, the first communication device can query corresponding transaction data in the blockchain based on the first blockchain information. In other words, the process in which the first communication device obtains, according to the network protocol, the first blockchain information of the second communication device online is converted into the bypass querying, to simplify deployment and promotion of blockchain application. Therefore, in the technical solutions of the disclosure, the second communication device does not need to send the address, in the blockchain, of the transaction data of the second communication device to the first communication device according to the network protocol. In other words, evolution and upgrade of the network protocol are not required, and the blockchain service can be directly used. Therefore, the blockchain-based network protocol is compatible with the network protocol of the current communication system. In addition, for the load-sensitive network protocol, the blockchain information is separated from the network protocol, to ensure that the load of the network protocol-based message does not increase due to introduction of the blockchain technology.

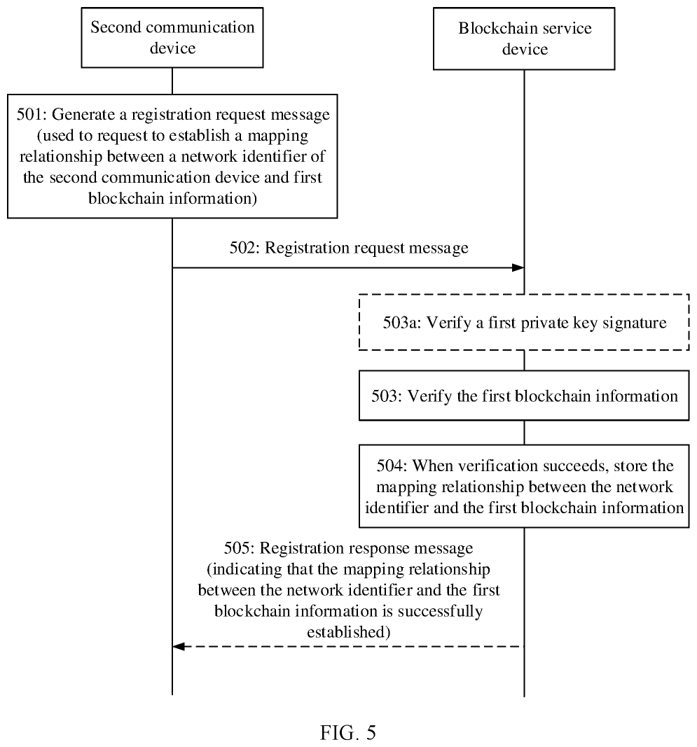

In the disclosure, optionally, the second communication device may request the blockchain service device to establish a mapping relationship between the second communication device and the first blockchain information. The following is described with reference to the embodiment shown in FIG. 5.

FIG. 5 is a schematic diagram of another embodiment of a communication method according to an embodiment of the disclosure. Refer to FIG. 5. The method includes the following blocks.

501: A second communication device generates a registration request message. The registration request message is used to request to establish a mapping relationship between a network identifier of the second communication device and first blockchain information.

In some implementations, the registration request message includes at least one of the following: the network identifier of the second communication device, a type of the network identifier, the first blockchain information, and a first private key signature.

For the network identifier and the first blockchain information, refer to related descriptions in the embodiment shown in FIG. 2.

For example, the type of the network identifier of the second communication device is an IP address, a MAC address, or an SUPI.

The first private key signature is a private key signature of the second communication device on the type of the network identifier of the second communication device, the network identifier of the second communication device, and the first blockchain information.

502: The second communication device sends the registration request message to a blockchain service device.

For example, the second communication device registers a blockchain account, and applies for an identifier, namely, a first blockchain identifier, of the second communication device in a blockchain. The first blockchain identifier may be understood as an address of the second communication device in the blockchain. The blockchain returns the first blockchain identifier to the second communication device. The second communication device may issue transaction data in the blockchain. First transaction data associated with the first blockchain identifier may be understood as transaction data of the blockchain account. Then, the second communication device generates the registration request message, and sends the registration request message to a first communication device, to request to establish a mapping relationship between the network identifier of the second communication device and the first blockchain identifier.

For example, the second communication device registers one or more blockchain accounts. The second communication device may send transaction data in the blockchain by using the one or more blockchain accounts. The second communication device may select a portion or all of the transaction data (for example, transaction data that the second communication device expects to disclose) of the one or more blockchain accounts. Then, the second communication device generates the registration request message, and sends the registration request message to the first communication device, to request to establish a mapping relationship between the network identifier of the second communication device and transaction identifiers of a portion or all of the transaction data. In this implementation, the second communication device may disclose specific transaction data in a targeted manner and does not need to provide all transaction data. This improves accuracy of obtaining data by the first communication device.

503: The blockchain service device verifies the first blockchain information.

Specifically, the blockchain service device requests the first blockchain information from the blockchain. When the blockchain service device obtains the first blockchain information from the blockchain, the blockchain service device may determine that the first blockchain information is authentic, to indicate that verification of the first blockchain information succeeds. When verification succeeds, the blockchain service device may perform block 504.

It should be noted that when the blockchain service device determines that the first blockchain information does not exist in the blockchain, that is, verification fails, the blockchain service device may indicate, to the second communication device, that registration fails, that is, indicate that the mapping relationship between the network identifier and the first blockchain information fails to be established.

Optionally, the embodiment shown in FIG. 5 further includes block 503a. Block 503a may be performed before block 503.

503a: The blockchain service device verifies the first private key signature.

Specifically, the registration request message includes the first private key signature of the second communication device. The blockchain service device verifies the first private key signature based on a public key of the second communication device; and when verification succeeds, performs block 503.

It should be noted that when verification fails, the blockchain service device may send a registration failure to the second communication device, that is, indicating that the mapping relationship between the network identifier and the first blockchain information fails to be established. In other words, the blockchain service device refuses to establish the mapping relationship between the network identifier and the first blockchain information for the second communication device.

It should be noted that there is no fixed sequence between block 503a and block 503 in the embodiment shown in FIG. 5. Block 503a may be performed before 503, block 503 may be performed before block 503a, or block 503a and block 503 are performed at the same time based on a situation. This is not specifically limited in the disclosure. In the embodiment shown in FIG. 5, an example in which block 503a is performed before block 503 is used for description.

504: When verification succeeds, the blockchain service device stores the mapping relationship between the network identifier of the second communication device and the first blockchain information.

When verification succeeds, the blockchain service device stores the mapping relationship between the network identifier of the second communication device and the first blockchain information.

For example, as shown in FIG. 3, the blockchain service device establishes a mapping relationship between the network identifier and the first blockchain identifier.

For example, as shown in FIG. 4, the blockchain service device establishes a mapping relationship between the network identifier and a first transaction identifier set.

The following describes several possible implementations in which the blockchain service device feeds back a registration result.

Implementation 1: If the mapping relationship between the network identifier and the first blockchain information is successfully established, the blockchain service device may send a registration success message to the second communication device, where the registration success message indicates that the mapping relationship between the network identifier of the second communication device and the first blockchain information is successfully established. If the mapping relationship between the network identifier and the first blockchain information fails to be established, the blockchain service device may feedback a registration failure message to the second communication device, where the registration failure message indicates that the mapping relationship between the network identifier and the first blockchain information fails to be established.

Implementation 2: If the mapping relationship between the network identifier and the first blockchain information is successfully established, the blockchain service device may send a registration success message to the second communication device, where the registration success message indicates that the mapping relationship between the network identifier of the second communication device and the first blockchain information is successfully established. If the mapping relationship between the network identifier and the first blockchain information fails to be established, the blockchain service device does not feedback any indication to the second communication device.

Implementation 3: If the mapping relationship between the network identifier and the first blockchain information is successfully established, the blockchain service device does not feed back any indication to the second communication device. If the mapping relationship between the network identifier and the first blockchain information fails to be established, the blockchain service device may feedback a registration failure message to the second communication device, where the registration failure message indicates that the mapping relationship between the network identifier and the first blockchain information fails to be established.

Optionally, the embodiment shown in FIG. 5 further includes block 505 based on the implementation 1 or the implementation 2. Block 505 may be performed after block 504.

505: The blockchain service device sends a registration response message to the second communication device, where the registration response message indicates that the mapping relationship between the network identifier and the first blockchain information is successfully established.

In the foregoing technical solutions in the embodiment shown in FIG. 5, the second communication device initiates a registration request to the blockchain service device, to request to establish the mapping relationship between the network identifier of the second communication device and the first blockchain information. Therefore, the blockchain service device can establish and store the mapping relationship between the network identifier of the second communication device and the first blockchain information. Therefore, the blockchain service device can provide a service of querying the first blockchain information for the first communication device. The first communication device can query corresponding transaction data in the blockchain based on the first blockchain information and perform corresponding secure connection and service determining.

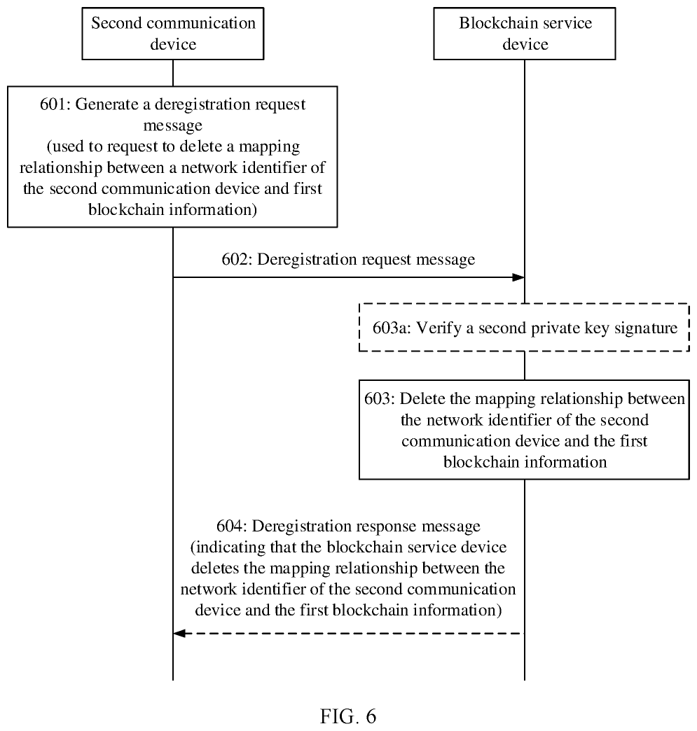

In the disclosure, optionally, the second communication device may request the blockchain service device to unbind the mapping relationship between the second communication device and the first blockchain information. The following is described with reference to the embodiment shown in FIG. 6.

FIG. 6 is a schematic diagram of another embodiment of a communication method according to an embodiment of the disclosure. Refer to FIG. 6. The method includes the following blocks.

601: A second communication device sends a deregistration request message to a blockchain service device, where the deregistration request message is used to request to delete a mapping relationship between a network identifier of the second communication device and first blockchain information.

For example, the second communication device does not expect disclosure of transaction data in a blockchain. In this case, the second communication device generates the deregistration request message, where the deregistration request message is used to request to unbind the mapping relationship between the network identifier of the second communication device and the first blockchain information.

In some implementations, the deregistration request message includes at least one of the following: a type of the network identifier of the second communication device, the network identifier, the first blockchain information, and a second private key signature. The second private key signature is a private key signature of the second communication device on the network identifier, the type of the network identifier, and the first blockchain information.

602: The second communication device sends the deregistration request message to a blockchain service device.

603: The blockchain service device deletes the mapping relationship, stored in the blockchain service device, between the network identifier of the second communication device and the first blockchain information.

Specifically, the blockchain service device deletes the mapping relationship between the network identifier of the second communication device and the first blockchain information. The blockchain service device stops a query service for the second communication device. In other words, when the blockchain service device receives a request that is of another communication device and that is used to query the first blockchain information, the blockchain service device may feedback a failure message, to indicate that querying fails.

Optionally, the embodiment shown in FIG. 6 further includes block 603a. Block 603a may be performed before block 603.

603a: The blockchain service device verifies the second private key signature.

Specifically, the blockchain service device verifies the second private key signature based on a public key of the second communication device. When verification succeeds, the blockchain service device may perform block 603.

It should be noted that when verification fails, the blockchain service device may send a deregistration failure to the second communication device, that is, the blockchain service device does not delete the mapping relationship between the network identifier and the first blockchain information.

The following describes several possible implementations in which the blockchain service device feeds back a deregistration result.

Implementation 1: If the mapping relationship between the network identifier and the first blockchain information is successfully deleted, the blockchain service device may send a deregistration success message to the second communication device, where the deregistration success message indicates that the blockchain service device deletes the mapping relationship between the network identifier of the second communication device and the first blockchain information. If the mapping relationship between the network identifier and the first blockchain information fails to be deleted, the blockchain service device may feed back a deregistration failure message to the second communication device, where the deregistration failure message indicates that the mapping relationship between the network identifier and the first blockchain information fails to be deleted.

Implementation 2: If the mapping relationship between the network identifier and the first blockchain information is successfully deleted, the blockchain service device may send a deregistration success message to the second communication device, where the deregistration success message indicates that the mapping relationship between the network identifier of the second communication device and the first blockchain information is successfully deleted. If the mapping relationship between the network identifier and the first blockchain information fails to be deleted, the blockchain service device does not feed back any indication to the second communication device.

Implementation 3: If the mapping relationship between the network identifier and the first blockchain information is successfully deleted, the blockchain service device does not feed back any indication to the second communication device. If the mapping relationship between the network identifier and the first blockchain information fails to be deleted, the blockchain service device may feed back a deregistration failure message to the second communication device, where the deregistration failure message indicates that the mapping relationship between the network identifier and the first blockchain information fails to be deleted.

Optionally, the embodiment shown in FIG. 6 further includes block 604 based on the implementation 1 or the implementation 2. Block 604 may be performed after block 603.

604: The blockchain service device sends a deregistration response message to the second communication device. The deregistration response message indicates that the blockchain service device deletes the mapping relationship between the network identifier of the second communication device and the first blockchain information.

In other words, the deregistration response message indicates that the blockchain service device successfully deletes the mapping relationship between the network identifier of the second communication device and the first blockchain information.

In the foregoing technical solutions in the embodiment shown in FIG. 6, the second communication device initiates a deregistration request to the blockchain service device, to request to delete the mapping relationship between the network identifier of the second communication device and the first blockchain information. For example, the second communication device does not expect disclosure of the transaction data associated with the first blockchain information. In this case, the second communication device may request to delete the mapping relationship between the network identifier of the second communication device and the first blockchain information. Therefore, the blockchain service device can provide a service of querying the first blockchain information. This can flexibly enable or disable the query service with reference to a requirement of the second communication device.

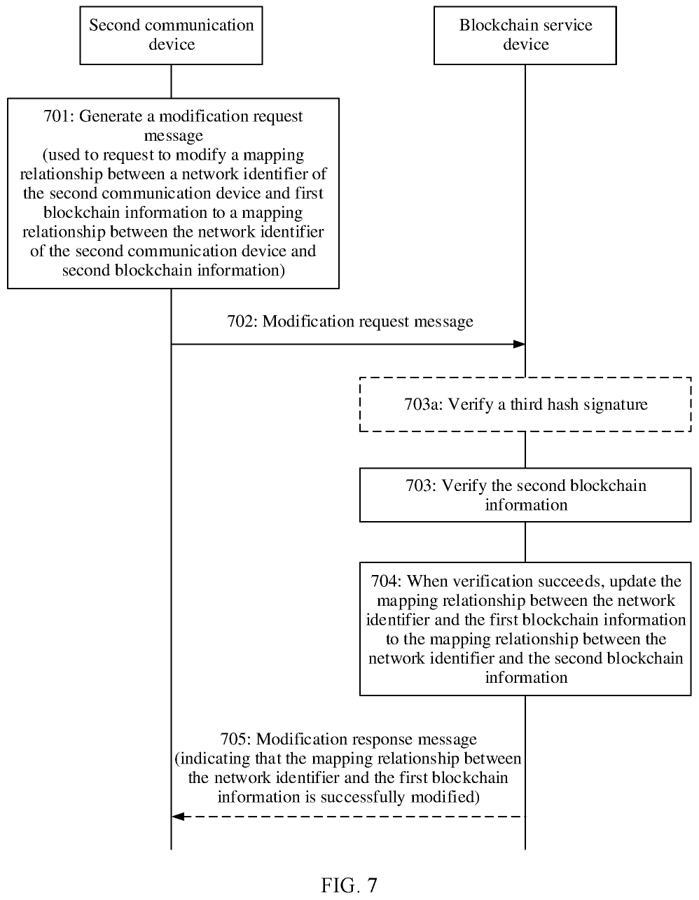

In the disclosure, optionally, the second communication device may request the blockchain service device to modify the mapping relationship between the second communication device and the first blockchain information. The following is described with reference to the embodiment shown in FIG. 7.

FIG. 7 is a schematic diagram of another embodiment of a communication method according to an embodiment of the disclosure. Refer to FIG. 7. The method includes the following blocks.

701: A second communication device generates a modification request message. The modification request message is used to request to modify a mapping relationship between a network identifier and first blockchain information to a mapping relationship between the network identifier and second blockchain information.

In some embodiments, the second blockchain information includes a second blockchain identifier, and the second blockchain identifier is a second identifier of the second communication device in a blockchain. The second blockchain identifier is used by a first communication device to query, in the blockchain, third transaction data that is of the second communication device and that is associated with the second blockchain identifier. Alternatively, the second blockchain information includes a second transaction identifier set, and the second transaction identifier set includes one or more second transaction identifiers. The one or more second transaction identifiers are transaction identifiers, in the blockchain, of one or more pieces of fourth transaction data of the second communication device. The one or more second transaction identifiers are used by the first communication device to query the one or more pieces of fourth transaction data in the blockchain.

702: The second communication device sends the modification request message to a blockchain service device.

For example, the second communication device registers a first blockchain account and a second blockchain account. A first blockchain identifier is an identifier of the first blockchain account of the second communication device in the blockchain. The second blockchain identifier is an identifier of the second blockchain account of the second communication device in the blockchain. The second communication device originally requests the blockchain service device to establish a mapping relationship between the network identifier of the second communication device and the first blockchain identifier. If the second communication device does not disclose transaction data associated with the first blockchain identifier, but needs to disclose transaction data associated with the second blockchain identifier, the second communication device may request the blockchain service device to modify the mapping relationship between the network identifier of the second communication device and the first blockchain identifier to a mapping relationship between the network identifier of the second communication device and the second blockchain identifier.

For example, the second communication device performs some new transactions on one or more blockchain accounts, and generates new transaction data. The second communication device may further disclose the new transaction data. Therefore, the second communication device may request the blockchain service device to modify a mapping relationship between the network identifier of the second communication device and a first transaction identifier set to a mapping relationship between the network identifier of the second communication device and a second transaction identifier set. The second transaction identifier set may include a transaction identifier of the new transaction data.

In some implementations, the modification request message includes at least one of the following: the first blockchain information, the second blockchain information, and a third hash signature. The second communication device performs a hash operation on the first blockchain information and the second blockchain information, and then performs digital signing, to obtain the third hash signature.

703: The blockchain service device verifies the second blockchain information.

Specifically, the blockchain service device may request the second blockchain information from the blockchain. If the blockchain service device obtains the second blockchain information from the blockchain, the blockchain service device may determine authenticity of the second blockchain information (which indicates that verification of the second blockchain information succeeds). When verification succeeds, the blockchain service device may perform block 704.

It should be noted that when verification of the second blockchain information fails, the blockchain service device may feed back a modification failure to the second communication device.

Optionally, the embodiment shown in FIG. 7 further includes block 703a. Block 703a may be performed before block 703.

703a: The blockchain service device verifies the third hash signature.

Specifically, the modification request message includes the third hash signature. The blockchain service device verifies the third hash signature; and when verification succeeds, performs block 703.

It should be noted that when verification of the third hash signature fails, the blockchain service device may indicate, to the second communication device, that modification fails.

It should be noted that there is no fixed sequence between block 703a and block 703 in the embodiment shown in FIG. 7. Block 703a may be performed before 703, block 703 may be performed before block 703a, or block 703a and block 703 are performed at the same time based on a situation. This is not specifically limited in the disclosure. In the embodiment shown in FIG. 7, an example in which block 703a is performed before block 703 is used for description.

704: When verification succeeds, the blockchain service device modifies the mapping relationship between the network identifier and the first blockchain information to the mapping relationship between the network identifier and the second blockchain information.

The following describes several possible implementations in which the blockchain service device feeds back a modification result.

Implementation 1: If the mapping relationship between the network identifier and the first blockchain information is successfully modified, the blockchain service device may send a modification success message to the second communication device, where the modification success message indicates that the mapping relationship between the network identifier and the first blockchain information is successfully modified. If the mapping relationship between the network identifier and the first blockchain information fails to be modified, the blockchain service device may send a modification failure message to the second communication device, where the modification failure message indicates that the mapping relationship between the network identifier and the first blockchain information fails to be modified.

Implementation 2: If the mapping relationship between the network identifier and the first blockchain information is successfully modified, the blockchain service device does not feed back any indication to the second communication device. If the mapping relationship between the network identifier and the first blockchain information fails to be modified, the blockchain service device may send a modification failure message to the second communication device, where the modification failure message indicates that the mapping relationship between the network identifier and the first blockchain information fails to be modified.

Implementation 3: If the mapping relationship between the network identifier and the first blockchain information is successfully modified, the blockchain service device may send a modification success message to the second communication device, where the modification success message indicates that the mapping relationship between the network identifier and the first blockchain information is successfully modified. If the mapping relationship between the network identifier and the first blockchain information fails to be modified, the blockchain service device does not feed back any indication to the second communication device.

Optionally, the embodiment shown in FIG. 7 further includes block 705 based on the implementation 1 or the implementation 2. Block 705 may be performed after block 704.

705: The blockchain service device sends a modification response message to the second communication device, where the modification response message indicates that the mapping relationship between the network identifier and the first blockchain information is successfully modified.

In the foregoing technical solutions in the embodiment shown in FIG. 7, the second communication device initiates a modification request to the blockchain service device, to request to modify the mapping relationship between the network identifier of the second communication device and the first blockchain information. Therefore, the second communication device can flexibly disclose corresponding transaction data. For example, the blockchain service device modifies a mapping relationship between the network identifier of the second communication device and first transaction identifier information to a mapping relationship between the network identifier of the second communication device and second transaction identifier information based on the modification request of the second communication device. The second transaction identifier information may include a transaction identifier of new transaction data. Therefore, the blockchain service device can provide a service of querying the second transaction identifier information, so that the first communication device obtains the new transaction data in the blockchain.

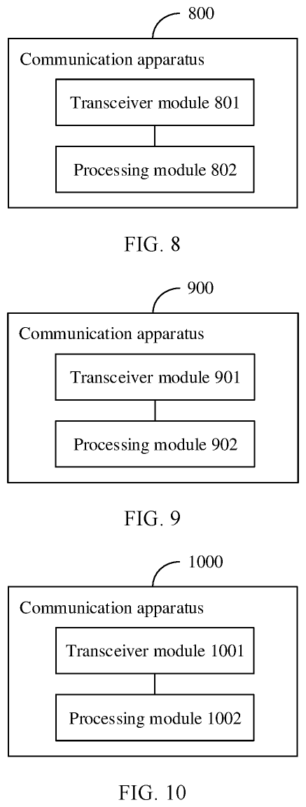

The following describes a communication apparatus provided in embodiments of the disclosure. FIG. 8 is a schematic diagram of a structure of a communication apparatus according to an embodiment of the disclosure. A communication apparatus 800 may be configured to perform blocks performed by the first communication device in the embodiment shown in FIG. 2. For details, refer to related descriptions in the foregoing method embodiments.

The communication apparatus 800 includes a transceiver module 801 and a processing module 802. The transceiver module 801 may implement a corresponding communication function, and the transceiver module 801 may also be referred to as a communication interface or a communication unit. The processing module 802 is configured to perform a processing operation.

Optionally, the communication apparatus 800 may further include a storage module. The storage module may be configured to store instructions and/or data. The processing module 802 may read the instructions and/or the data in the storage module, so that the communication apparatus implements the foregoing method embodiment shown in FIG. 2.

The communication apparatus 800 may be configured to perform an action performed by the first communication device in the foregoing method embodiments. The communication apparatus 800 may be the first communication device or a component disposed in the first communication device. The transceiver module 801 is configured to perform a receiving-related operation on a side of the first communication device in the foregoing method embodiment, and the processing module 802 is configured to perform a processing-related operation on the side of the first communication device in the foregoing method embodiment.

Optionally, the transceiver module 801 may include a sending module and a receiving module. The sending module is configured to perform a sending operation in the method embodiment shown in FIG. 2. The receiving module is configured to perform a receiving operation in the method embodiment shown in FIG. 2.

It should be noted that the communication apparatus 800 may include a sending module, but does not include a receiving module. Alternatively, the communication apparatus 800 may include a receiving module, but does not include a sending module. Specifically, which module is included in the communication apparatus may be determined based on whether the foregoing solution performed by the communication apparatus 800 includes a sending action and a receiving action.

The transceiver module 801 is configured to obtain a network identifier of a second communication device.

The processing module 802 is configured to generate a query request based on the network identifier of the second communication device.

The transceiver module 801 is further configured to send the query request to a blockchain service device and receive first blockchain information from the blockchain service device.

The query request is used to request the first blockchain information corresponding to the network identifier of the second communication device; the first blockchain information includes a first blockchain identifier, and the first blockchain identifier is used by the communication apparatus 800 to query, in a blockchain, first transaction data that is of the second communication device and that is associated with the first blockchain identifier, or the first blockchain information includes a first transaction identifier set, the first transaction identifier set includes one or more first transaction identifiers, and the one or more first transaction identifiers are transaction identifiers, in the blockchain, of one or more pieces of second transaction data of the second communication device; and the first transaction identifier set is used by the communication apparatus 800 to query the one or more pieces of second transaction data in the blockchain.

In a possible implementation, the query request includes the network identifier, and the network identifier includes any one of the following: an IP address, a MAC address, a network layer identifier, an SUPI, an SUCI, a GUTI, an IMEI, a PLMN_ID, a public key hash value, and domain name information that are of the second communication device.

In another possible implementation, the transceiver module 801 is further configured to obtain first authorization information, where the first authorization information is authorization information provided by the second communication device for the query request.

In another possible implementation, the query request further includes the first authorization information.

In another possible implementation, the first authorization information includes at least one of the following: the network identifier of the second communication device, a time range within which query is allowed, a network identifier of the communication apparatus 800, the first transaction identifier set, and a transaction identifier of the first transaction data.

In another possible implementation, the processing module 802 is configured to:
determine that the first blockchain information corresponding to the network identifier does not exist in the communication apparatus 800.

In another possible implementation, the processing module 802 is further configured to:
store a mapping relationship between the network identifier and the first blockchain information.

In another possible implementation, the first blockchain information includes the first blockchain identifier, and the processing module 802 is further configured to:
query the first transaction data in the blockchain based on the first blockchain identifier.

In another possible implementation, the first blockchain information includes the first transaction identifier set, and the processing module 802 is further configured to:
query the one or more pieces of second transaction data in the blockchain based on the first transaction identifier set.

In this embodiment of the disclosure, the transceiver module 801 is configured to obtain the network identifier of the second communication device. The processing module 802 is configured to generate the query request based on the network identifier of the second communication device. The transceiver module 801 is further configured to send the query request to the blockchain service device and receive the first blockchain information from the blockchain service device. The query request is used to request the first blockchain information corresponding to the network identifier of the second communication device; the first blockchain information includes the first blockchain identifier, and the first blockchain identifier is used by the communication apparatus 800 to query, in the blockchain, the first transaction data that is of the second communication device and that is associated with the first blockchain identifier, or the first blockchain information includes the first transaction identifier set, the first transaction identifier set includes the one or more first transaction identifiers, and the one or more first transaction identifiers are the transaction identifiers, in the blockchain, of the one or more pieces of second transaction data of the second communication device; and the first transaction identifier set is used by the communication apparatus 800 to query the one or more pieces of second transaction data in the blockchain. It can be learned that the second communication device does not need to send an address, in a blockchain, of transaction data of the second communication device to the communication apparatus 800 according to a network protocol. In other words, modification and evolution of the network protocol are not required, so that a blockchain-based network protocol is compatible with a network protocol of a current communication system.

The following describes a communication apparatus provided in embodiments of the disclosure. FIG. 9 is a schematic diagram of a structure of a communication apparatus according to an embodiment of the disclosure. A communication apparatus 900 may be configured to perform blocks performed by the blockchain service device in embodiments shown in FIG. 2, FIG. 5, FIG. 6, and FIG. 7. For details, refer to related descriptions in the foregoing method embodiments.

The communication apparatus 900 includes a transceiver module 901 and a processing module 902. The transceiver module 901 may implement a corresponding communication function, and the transceiver module 901 may also be referred to as a communication interface or a communication unit. The processing module 902 is configured to perform processing operations such as information verification and storing.

Optionally, the communication apparatus 900 may further include a storage module. The storage module may be configured to store instructions and/or data. The processing module 902 may read the instructions and/or the data in the storage module, so that the communication apparatus implements the foregoing method embodiments.

The communication apparatus 900 may be configured to perform an action performed by the blockchain service device in the foregoing method embodiments. The communication apparatus 900 may be the blockchain service device or a component disposed in the blockchain service device. The transceiver module 901 is configured to perform a receiving-related operation on a side of the blockchain service device in the foregoing method embodiments, and the processing module 902 is configured to perform a processing-related operation on the side of the blockchain service device in the foregoing method embodiments.

Optionally, the transceiver module 901 may include a sending module and a receiving module. The sending module is configured to perform a sending operation in the method embodiments. The receiving module is configured to perform a receiving operation in the method embodiments.

It should be noted that the communication apparatus 900 may include a sending module, but does not include a receiving module. Alternatively, the communication apparatus 900 may include a receiving module, but does not include a sending module. Specifically, which module is included in the communication apparatus may be determined based on whether the foregoing solution performed by the communication apparatus 900 includes a sending action and a receiving action.

The transceiver module 901 is configured to receive a query request from a first communication device.

The processing module 902 is configured to determine first blockchain information based on the query request.

The transceiver module 901 is further configured to send the first blockchain information to the first communication device.

The query request is used to request the first blockchain information corresponding to a network identifier of a second communication device; the first blockchain information includes a first blockchain identifier, and the first blockchain identifier is used by the first communication device to query, in a blockchain, first transaction data that is of the second communication device and that is associated with the first blockchain identifier, or the first blockchain information includes a first transaction identifier set, the first transaction identifier set includes one or more first transaction identifiers, and the one or more first transaction identifiers are transaction identifiers, in the blockchain, of one or more pieces of second transaction data of the second communication device; and the first transaction identifier set is used by the first communication device to query the one or more pieces of second transaction data in the blockchain.

In a possible implementation, the query request includes the network identifier, and the network identifier includes any one of the following: an IP address, a MAC address, a network layer identifier, an SUPI, an SUCI, a GUTI, an IMEI, a PLMN_ID, a public key hash value, and domain name information that are of the second communication device.

In another possible implementation, the transceiver module 901 is further configured to:
receive first authorization information from the second communication device, where the first authorization information is authorization information provided by the second communication device for the query request.

In another possible implementation, the query request further includes the first authorization information, where the first authorization information is authorization information provided by the second communication device for the query request.

In another possible implementation, the processing module 902 is further configured to:
verify the first authorization information; and when verification succeeds, perform the block of sending the first blockchain information to the first communication device.

In another possible implementation, the transceiver module 901 is further configured to:
send the first authorization information to the first communication device.

In another possible implementation, the first authorization information includes at least one of the following: the network identifier of the second communication device, a time range within which query is allowed, a network identifier of the first communication device, the first transaction identifier set, and a transaction identifier of the first transaction data.

In another possible implementation, the transceiver module 901 is further configured to:
receive a registration request message from the second communication device, where the registration request message is used to request to establish a mapping relationship between the network identifier and the first blockchain information.

The processing module 902 is further configured to:
verify the first blockchain information; and when verification of the first blockchain information succeeds, store the mapping relationship between the network identifier and the first blockchain information.

In another possible implementation, the transceiver module 901 is further configured to:
send a registration response message to the second communication device, where the registration response message indicates that the mapping relationship between the network identifier and the first blockchain information is successfully established.

In another possible implementation, the transceiver module 901 is further configured to:
receive a deregistration request message from the second communication device, where the deregistration request message is used to request to delete the mapping relationship between the network identifier and the first blockchain information; and send a deregistration response message to the second communication device, where the deregistration response message indicates that the communication apparatus 900 deletes the mapping relationship between the network identifier and the first blockchain information.

In another possible implementation, the transceiver module 901 is further configured to:
receive a modification request message from the second communication device, where the modification request message includes the first blockchain information and second blockchain information; the second blockchain information includes a second blockchain identifier, and the second blockchain identifier is used by the first communication device to query, in the blockchain, third transaction data that is of the second communication device and that is associated with the second blockchain identifier, or the second blockchain information includes a second transaction identifier set, the second transaction identifier set includes one or more second transaction identifiers, the one or more second transaction identifiers are transaction identifiers, in the blockchain, of one or more pieces of fourth transaction data of the second communication device, and the one or more second transaction identifiers are used by the first communication device to query the one or more pieces of fourth transaction data in the blockchain; and the modification request message is used to request to modify the mapping relationship between the network identifier and the first blockchain information to a mapping relationship between the network identifier and the second blockchain information; and
send a modification response message to the second communication device, where the modification response message indicates that the mapping relationship between the network identifier and the first blockchain information is successfully modified.

In this embodiment of the disclosure, the transceiver module 901 is configured to receive the query request from the first communication device. The processing module 902 is configured to determine the first blockchain information based on the query request. The transceiver module 901 is further configured to send the first blockchain information to the first communication device. The query request is used to request the first blockchain information corresponding to the network identifier of the second communication device; the first blockchain information includes the first blockchain identifier, and the first blockchain identifier is used by the first communication device to query, in the blockchain, the first transaction data that is of the second communication device and that is associated with the first blockchain identifier, or the first blockchain information includes the first transaction identifier set, the first transaction identifier set includes the one or more first transaction identifiers, and the one or more first transaction identifiers are the transaction identifiers, in the blockchain, of the one or more pieces of second transaction data of the second communication device; and the first transaction identifier set is used by the first communication device to query the one or more pieces of second transaction data in the blockchain. It can be learned that the transceiver module 901 sends the first blockchain information to the first communication device, so that the first communication device can query corresponding transaction data in the blockchain based on the first blockchain information. The second communication device does not need to send an address, in the blockchain, of transaction data of the second communication device to the first communication device according to a network protocol. In other words, modification and evolution of the network protocol are not required, so that a blockchain-based network protocol is compatible with a network protocol of a current communication system.

The following describes a communication apparatus provided in embodiments of the disclosure. FIG. 10 is a schematic diagram of a structure of a communication apparatus according to an embodiment of the disclosure. A communication apparatus 1000 may be configured to perform blocks performed by the second communication device in embodiments shown in FIG. 5, FIG. 6, and FIG. 7. For details, refer to related descriptions in the foregoing method embodiments.

The communication apparatus 1000 includes a transceiver module 1001 and a processing module 1002. The transceiver module 1001 may implement a corresponding communication function, and the transceiver module 1001 may also be referred to as a communication interface or a communication unit. The processing module 1002 is configured to perform a processing operation.

Optionally, the communication apparatus 1000 may further include a storage module. The storage module may be configured to store instructions and/or data. The processing module 1002 may read the instructions and/or the data in the storage module, so that the communication apparatus implements the foregoing method embodiments.

The communication apparatus 1000 may be configured to perform an action performed by the second communication device in the foregoing method embodiments. The communication apparatus 1000 may be the second communication device or a component disposed in the second communication device. The transceiver module 1001 is configured to perform a receiving-related operation on a side of the second communication device in the foregoing method embodiments, and the processing module 1002 is configured to perform a processing-related operation on the side of the second communication device in the foregoing method embodiments.

Optionally, the transceiver module 1001 may include a sending module and a receiving module. The sending module is configured to perform a sending operation in the method embodiments. The receiving module is configured to perform a receiving operation in the method embodiments.

It should be noted that the communication apparatus 1000 may include a sending module, but does not include a receiving module. Alternatively, the communication apparatus 1000 may include a receiving module, but does not include a sending module. Specifically, which module is included in the communication apparatus may be determined based on whether the foregoing solution performed by the communication apparatus 1000 includes a sending action and a receiving action.

The processing module 1002 is configured to generate a registration request message. The registration request message is used to request to establish a mapping relationship between a network identifier of the communication apparatus 1000 and first blockchain information of the communication apparatus 1000, the first blockchain information includes a first blockchain identifier of the communication apparatus 1000, and the first blockchain identifier is associated with first transaction data of the communication apparatus 1000, or the first blockchain information includes a first transaction identifier set, the first transaction identifier set includes one or more first transaction identifiers, and the one or more first transaction identifiers are transaction identifiers, in a blockchain, of one or more pieces of second transaction data of the communication apparatus 1000.

The transceiver module 1001 is configured to send the registration request message to a blockchain service device.

In a possible implementation, the registration request message includes the network identifier, and the network identifier includes any one of the following: an IP address, a MAC address, a network layer identifier, a SUPI, a SUCI, a GUTI, an IMEI, a PLMN_ID, a public key hash value, and domain name information that are of the communication apparatus 1000.

In another possible implementation, the transceiver module 1001 is further configured to:
receive a registration response message from the blockchain service device, where the registration response message indicates that the mapping relationship between the network identifier and the first blockchain information is successfully established.

In another possible implementation, the transceiver module 1001 is further configured to:
send first authorization information, where the first authorization information is authorization information provided by the communication apparatus 1000 for a query request of the first communication device.

In another possible implementation, the transceiver module 1001 is further configured to:
send a deregistration request message to the blockchain service device, where the deregistration request message is used to request to delete the mapping relationship between the network identifier and the first blockchain information; and
receive a deregistration response message from the blockchain service device, where the deregistration response message indicates that the blockchain service device deletes the mapping relationship between the network identifier and the first blockchain information.

In another possible implementation, the transceiver module 1001 is further configured to:
send a modification request message to the blockchain service device, where the modification request message includes the first blockchain information and second blockchain information; the second blockchain information includes a second blockchain identifier, and the second blockchain identifier is used by the first communication device to query, in the blockchain, third transaction data that is of the communication apparatus 1000 and that is associated with the second blockchain identifier, or the second blockchain information includes a second transaction identifier set, the second transaction identifier set includes one or more second transaction identifiers, the one or more transaction identifiers are transaction identifiers, in the blockchain, of one or more pieces of fourth transaction data of the communication apparatus 1000, and the one or more second transaction identifiers are used by the first communication device to query the one or more pieces of fourth transaction data in the blockchain; and the modification request message is used to request to modify the mapping relationship between the network identifier and the first blockchain information to a mapping relationship between the network identifier and the second blockchain information; and
receive an acknowledgment message from the blockchain service device, where the acknowledgment message indicates that the mapping relationship between the network identifier and the first blockchain information is successfully modified.

In this embodiment of the disclosure, the processing module 1002 is configured to generate the registration request message. The transceiver module 1001 is configured to send the registration request message to the blockchain service device. The registration request message is used to request to establish the mapping relationship between the network identifier of the communication apparatus 1000 and the first blockchain information of the communication apparatus 1000, the first blockchain information includes the first blockchain identifier of the communication apparatus 1000, and the first blockchain identifier is associated with the first transaction data of the communication apparatus 1000, or the first blockchain information includes the first transaction identifier set, the first transaction identifier set includes the one or more first transaction identifiers, and the one or more first transaction identifiers are the transaction identifiers, in the blockchain, of the one or more pieces of second transaction data of the communication apparatus 1000. It can be learned that the transceiver module 1001 initiates a registration request to the blockchain service device, to request to establish the mapping relationship between the network identifier of the communication apparatus 1000 and the first blockchain information. Therefore, the blockchain service device can establish and store the mapping relationship between the network identifier of the communication apparatus 1000 and the first blockchain information. Therefore, the blockchain service device can provide a service of querying the first blockchain information for the first communication device. The first communication device can query corresponding transaction data in the blockchain based on the first blockchain information and perform corresponding secure connection and service determining. The communication apparatus 1000 does not need to send an address of transaction data in the blockchain to the first communication device according to a network protocol. In other words, evolution and upgrade of the network protocol are not required, and a blockchain service can be directly used. Therefore, a blockchain-based network protocol is compatible with a network protocol of a current communication system. In addition, for a load-sensitive network protocol, blockchain information is separated from the network protocol, to ensure that load of a network protocol-based message does not increase due to introduction of a blockchain technology.

An embodiment of the disclosure further provides a communication apparatus 1100. The communication apparatus 1100 includes a processor 1110. The processor 1110 is coupled to a memory 1120. The memory 1120 is configured to store a computer program or instructions and/or data. The processor 1110 is configured to perform the computer program or the instructions and/or the data stored in the memory 1120, so that the method in the foregoing method embodiments is performed.

Optionally, the communication apparatus 1100 includes one or more processors 1110.

Optionally, as shown in FIG. 11, the communication apparatus 1100 may further include the memory 1120.

Optionally, the communication apparatus 1100 may include one or more memories 1120.

Optionally, the memory 1120 and the processor 1110 may be integrated, or separately disposed.

Optionally, as shown in FIG. 11, the communication apparatus 1100 may further include a transceiver 1130. The transceiver 1130 is configured to receive and/or send a signal. For example, the processor 1110 is configured to control the transceiver 1130 to receive and/or send a signal.

In a solution, the communication apparatus 1100 is configured to perform the operations performed by the first communication device in the foregoing method embodiment.

For example, the processor 1110 is configured to perform a processing-related operation performed by the first communication device in the foregoing method embodiment, and the transceiver 1130 is configured to perform a receiving/sending-related operation performed by the first communication device in the foregoing method embodiment.

When the communication apparatus 1100 is a chip, the chip includes an input/output circuit or a communication interface, and the processor is an integrated processor, a microprocessor, or an integrated circuit on the chip. A sending operation performed by the first communication device in the foregoing method embodiment may be understood as an output of the chip, and a receiving operation performed by the first communication device in the foregoing method embodiment may be understood as an input of the chip.

In a solution, the communication apparatus 1100 is configured to perform the operations performed by the blockchain service device in the foregoing method embodiments.

For example, the processor 1110 is configured to perform a processing-related operation performed by the blockchain service device in the foregoing method embodiments, and the transceiver 1130 is configured to perform a receiving/sending-related operation performed by the blockchain service device in the foregoing method embodiments.

When the communication apparatus 1100 is a chip, the chip includes a transceiver, a memory, and a processor. The transceiver may be an input/output circuit or a communication interface, and the processor is an integrated processor, a microprocessor, or an integrated circuit on the chip. A sending operation performed by the blockchain service device in the foregoing method embodiments may be understood as an output of the chip, and a receiving operation performed by the blockchain service device in the foregoing method embodiments may be understood as an input of the chip.

In a solution, the communication apparatus 1100 is configured to perform the operations performed by the second communication device in the foregoing method embodiments.

For example, the processor 1110 is configured to perform a processing-related operation performed by the second communication device in the foregoing method embodiments, and the transceiver 1130 is configured to perform a receiving/sending-related operation performed by the second communication device in the foregoing method embodiments.

When the communication apparatus 1100 is a chip, the chip includes a transceiver, a memory, and a processor. The transceiver may be an input/output circuit or a communication interface, and the processor is an integrated processor, a microprocessor, or an integrated circuit on the chip. A sending operation performed by the second communication device in the foregoing method embodiments may be understood as an output of the chip, and a receiving operation performed by the second communication device in the foregoing method embodiments may be understood as an input of the chip.

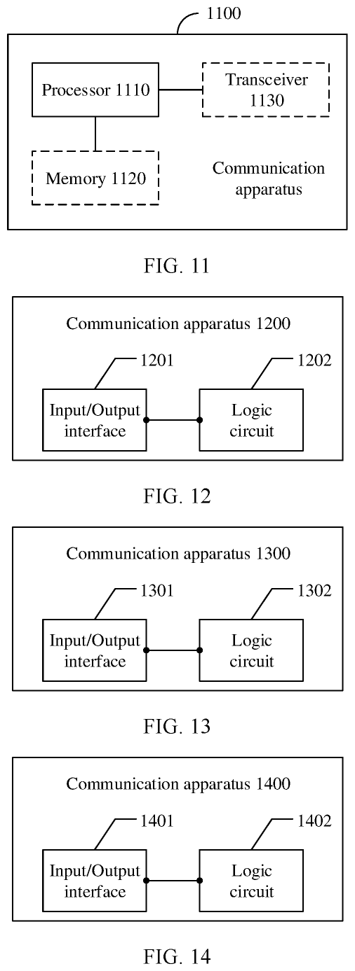

The disclosure further provides another communication apparatus. FIG. 12 is a schematic diagram of another structure of a communication apparatus according to the disclosure. The communication apparatus 1200 includes an input/output interface 1201 and a logic circuit 1202.

In a possible implementation, the communication apparatus 1200 may be configured to perform some or all of the blocks performed by the first communication device in the embodiment shown in FIG. 2.

Optionally, the input/output interface 1201 may have a function of the transceiver module 801 in the embodiment shown in FIG. 8. The logic circuit 1202 may have a function of the processing module 802 in the embodiment shown in FIG. 8.

Optionally, the input/output interface 1201 may be configured to perform a sending operation or a receiving operation performed by the first communication device in the foregoing communication method, and the logic circuit 1202 may be configured to perform a processing operation performed by the first communication device in the foregoing communication method. For example, the operation is a storage operation.

The disclosure further provides another communication apparatus. FIG. 13 is a schematic diagram of another structure of a communication apparatus according to the disclosure. The communication apparatus 1300 includes an input/output interface 1301 and a logic circuit 1302.

In a possible implementation, the communication apparatus 1300 may be configured to perform some or all of the blocks performed by the blockchain service device in embodiments shown in FIG. 2, FIG. 5, FIG. 6, and FIG. 7.

Optionally, the input/output interface 1301 may have a function of the transceiver module 901 in the embodiment shown in FIG. 9. The logic circuit 1302 may have a function of the processing module 902 in the embodiment shown in FIG. 9.

Optionally, the input/output interface 1301 may be configured to perform a sending operation or a receiving operation performed by the blockchain service device in the foregoing communication method, and the logic circuit 1302 may be configured to perform a processing operation performed by the blockchain service device in the foregoing communication method. For example, the operation is a verification operation or a storage operation.

The disclosure further provides another communication apparatus. FIG. 14 is a schematic diagram of another structure of a communication apparatus according to the disclosure. The communication apparatus 1400 includes an input/output interface 1401 and a logic circuit 1402.

In a possible implementation, the communication apparatus 1400 may be configured to perform some or all of the blocks performed by the second communication device in embodiments shown in FIG. 5, FIG. 6, and FIG. 7.

Optionally, the input/output interface 1401 may have a function of the transceiver module 1001 in the embodiment shown in FIG. 10. The logic circuit 1402 may have a function of the processing module 1002 in the embodiment shown in FIG. 10.

Optionally, the input/output interface 1401 may be configured to perform a sending operation or a receiving operation performed by the second communication device in the foregoing communication method, and the logic circuit 1402 may be configured to perform a processing operation performed by the second communication device in the foregoing communication method. For example, the operation is an operation of generating a message.

Embodiments of the disclosure further provide a computer-readable storage medium. The computer-readable storage medium stores computer instructions for implementing the method performed by the terminal device or the method performed by the network device in the foregoing method embodiments.

For example, when a computer program is executed by a computer, the computer is enabled to implement the method performed by the terminal device or the method performed by the network device in the foregoing method embodiments.

Embodiments of the disclosure further provide a computer program product including instructions. When the instructions are executed by a computer, the computer is enabled to implement the method performed by the terminal device or the method performed by the network device in the foregoing method embodiments.

An embodiment of the disclosure further provides a communication system. The communication system includes the first communication device, the blockchain service device, and the second communication device in the foregoing embodiments.

An embodiment of the disclosure further provides a chip apparatus, including a processor, configured to invoke a computer program or computer instructions in a memory, to enable the processor to perform the method in embodiments shown in FIG. 2, FIG. 5, FIG. 6, and FIG. 7.

In a possible implementation, an input of the chip apparatus corresponds to the receiving operation in embodiments shown in FIG. 2, FIG. 5, FIG. 6, and FIG. 7, and an output of the chip apparatus corresponds to the sending operation in embodiments shown in FIG. 2, FIG. 5, FIG. 6, and FIG. 7.

Optionally, the processor is coupled to the memory through an interface, or the processor and the memory are integrated together.

Optionally, the chip apparatus further includes the memory. The memory stores the computer program or the computer instructions.

The processor mentioned anywhere above may be a general-purpose central processing unit, a microprocessor, an application-specific integrated circuit (ASIC), or one or more integrated circuits configured to control program execution of the method in embodiments shown in FIG. 2, FIG. 5, FIG. 6, and FIG. 7. The memory mentioned in any one of the foregoing may be a read-only memory (ROM), another type of static storage device that can store static information and instructions, a random access memory (RAM), or the like.

It may be clearly understood by a person skilled in the art that, for the purpose of convenient and brief description, for explanations of related content and beneficial effect in any one of the foregoing provided communication apparatuses, refer to corresponding method embodiments provided above. Details are not described herein again.

It may be clearly understood by a person skilled in the art that, for the purpose of convenient and brief description, for a detailed working process of the foregoing system, apparatus, and module, refer to a corresponding process in the foregoing method embodiments. Details are not described herein again.

In the several embodiments provided in the disclosure, it should be understood that the disclosed system, apparatus, and method may be implemented in another manner. For example, the apparatus embodiment described above is merely an example. For example, the module division is merely logical function division and may be other division during actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or modules may be implemented in electronic, mechanical, or other forms.

The modules described as separate parts may or may not be physically separate, and parts displayed as modules may or may not be physical modules, may be located in one position, or may be distributed on a plurality of network modules. Some or all the modules may be selected based on actual requirements to achieve the objectives of the solutions of embodiments.

In addition, functional modules in embodiments of the disclosure may be integrated into one processing module, or each of the modules may exist alone physically, or two or more modules are integrated into one module. The integrated module may be implemented in a form of hardware, or may be implemented in a form of a software functional module.

When the integrated module is implemented in the form of a software functional module and sold or used as an independent product, the integrated unit may be stored in a computer-readable storage medium. Based on such an understanding, the technical solutions of the disclosure essentially, or the part contributing to the conventional technology, or all or some of the technical solutions may be implemented in the form of a software product. The computer software product is stored in a storage medium and includes several instructions for instructing a computer device (which may be a personal computer, a server, or a network device) to perform all or some of the blocks of the methods described in embodiments of the disclosure. The foregoing storage medium includes: any medium that can store program code, such as a USB flash drive, a removable hard disk, a read-only memory, a random access memory, a magnetic disk, or an optical disc.

In conclusion, the foregoing embodiments are merely intended for describing the technical solutions of the disclosure, but not for limiting the disclosure. Although the disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of the disclosure.

What is claimed is:

1. A method implemented by a first apparatus, comprising:
sending a query request to a blockchain service device, wherein the query request is associated with a network identifier of a second apparatus; and
receiving first blockchain information from the blockchain service device, wherein
the first blockchain information is associated with transaction data of the second apparatus and the transaction data is in a blockchain.

2. The method according to claim 1, wherein the query request comprises the network identifier.

3. The method according to claim 1, where the network identifier comprises any one of:
an Internet protocol (IP) address of the second apparatus,
a media access control (MAC) address of the second apparatus,
a network layer identifier of the second apparatus,
a subscription permanent identifier (SUPI) of the second apparatus,
a subscription concealed identifier (SUCI) of the second apparatus,
a globally unique temporary user equipment identifier (GUTI) of the second apparatus,
an international mobile equipment identity (IMEI) of the second apparatus,
a public land mobile network identifier (PLMN_ID) of the second apparatus,
a public key hash value of the second apparatus, or
domain name information of the second apparatus.

4. The method according to claim 1, further comprising:
obtaining first authorization information provided by the second apparatus.

5. The method according to claim 1, wherein the query request comprises first authorization information, wherein the first authorization information comprises one or more of:
the network identifier of the second apparatus,
a time range within which query is allowed,
a network identifier of a sender of the query request,
the first transaction identifier set, or
a transaction identifier of the first transaction data.

6. The method according to claim 1, further comprising:
storing a mapping relationship between the network identifier and the first blockchain information.

7. The method according to claim 1, where the first blockchain information comprises a first blockchain identifier associated with the transaction data of the second apparatus.

8. The method according to claim 1, where the first blockchain information comprises a first blockchain identifier set including a blockchain identifier associated with the transaction data of the second apparatus.

9. A first apparatus, comprising:
a memory;
one or more processors coupled to the memory and configured to:
send a query request to a blockchain service device, wherein the query request is associated with a network identifier of an apparatus; and
receive first blockchain information from the blockchain service device, wherein the first blockchain information is associated with transaction data of the apparatus and the transaction data is in a blockchain.

10. The first apparatus according to claim 9, wherein the query request comprises the network identifier.

11. The first apparatus according to claim 9, where the network identifier comprises any one of:
an Internet protocol (IP) address of the second apparatus,
a media access control (MAC) address of the second apparatus,
a network layer identifier of the second apparatus,
a subscription permanent identifier (SUPI) of the second apparatus,
a subscription concealed identifier (SUCI) of the second apparatus,
a globally unique temporary user equipment identifier (GUTI) of the second apparatus,
an international mobile equipment identity (IMEI) of the second apparatus,
a public land mobile network identifier (PLMN_ID) of the second apparatus,
a public key hash value of the second apparatus, or
domain name information of the second apparatus.

12. The first apparatus according to claim 9, where the one or more processors are further configured to: obtain first authorization information provided by the second apparatus.

13. The first apparatus according to claim 1, wherein the query request comprises first authorization information, wherein the first authorization information comprises one or more of:
the network identifier of the second apparatus,
a time range within which query is allowed,
a network identifier of a sender of the query request,
the first transaction identifier set, or
a transaction identifier of the first transaction data.

14. The first apparatus according to claim 9, where the one or more processors are further configured to: store a mapping relationship between the network identifier and the first blockchain information.

15. The first apparatus according to claim 9, where the first blockchain information comprises a first blockchain identifier associated with the transaction data of the second apparatus.

16. The first apparatus according to claim 9, where the first blockchain information comprises a first blockchain identifier set including a blockchain identifier associated with the transaction data of the second apparatus.

17. A non-transitory storage comprising a computer program or instructions, which when run on a computer, causes the computer to:
send a query request to a blockchain service device, wherein the query request is associated with a network identifier of an apparatus; and
receive first blockchain information from the blockchain service device, wherein the first blockchain information is associated with transaction data of the apparatus and the transaction data is in a blockchain.

18. The non-transitory storage according to claim 17, wherein the query request comprises the network identifier.

19. The non-transitory storage according to claim 17, where the network identifier comprises any one of:
an Internet protocol (IP) address of the second apparatus,
a media access control (MAC) address of the second apparatus,
a network layer identifier of the second apparatus,
a subscription permanent identifier (SUPI) of the second apparatus,
a subscription concealed identifier (SUCI) of the second apparatus,
a globally unique temporary user equipment identifier (GUTI) of the second apparatus,
an international mobile equipment identity (IMEI) of the second apparatus,
a public land mobile network identifier (PLMN_ID) of the second apparatus,
a public key hash value of the second apparatus, or
domain name information of the second apparatus.

20. The non-transitory storage according to claim 17, where when the computer program or instructions run on the computer, further causes the computer to: obtain first authorization information provided by the second apparatus.
